(19) United States
(12) Patent Application Publication
(10) Pub. No.: US 2023/0382690 A1
(43) Pub. Date: Nov. 30, 2023

(54) REMOTELY OPERABLE LIFTING EQUIPMENT

(71) Applicants: Caine Ian LUMSDEN, Hamilton (NZ); Ross James LUMSDEN, Hamilton (NZ)

(72) Inventors: Caine Ian LUMSDEN, Hamilton (NZ); Ross James LUMSDEN, Hamilton (NZ)

(21) Appl. No.: 18/248,270

(22) PCT Filed: Oct. 12, 2021
(86) PCT No.: PCT/NZ2021/050174

§ 371 Date: Apr. 7, 2023

(30) Foreign Application Priority Data
Oct. 12, 2020 (NZ) 768852
Jan. 14, 2021 (NZ) 771929

(51) Int. Cl. B66C 1/36; B66C 1/66

(52) U.S. Cl. CPC B66C 1/36; B66C 1/666; E04G 21/142

(57) ABSTRACT

A clutch for lifting a load with a lifting point includes a body with a cavity with an opening at a side of the body receiving the lifting point into the cavity, a first lever and a second lever. The second lever is movably coupled to the body to move between a close position and an open position to block and unlock the opening. The first lever is movably coupled to the body to move between an engaged position and a disengaged position, in the engaged position the first lever engages the second lever to maintain the second lever in the closed position, and in the disengaged position the second lever is disengaged from the second lever so that the second lever is free to move to the open position. The clutch is releasable from the lifting point by pulling the first lever to move it to the disengaged position.

### STATEMENT OF CORRESPONDING APPLICATIONS

This application is based on the provisional specifications filed in relation to New Zealand Patent Application Numbers 768852 and 771929, the entire contents of which are incorporated herein by reference.

### FIELD OF INVENTION

The invention relates to remotely operable lifting equipment, and in particular a remotely operable hook for lifting a load, and/or a clutch mechanism for use with a remotely operable hook or release system for lifting a load, and/or a system for uses with a lifting apparatus for lifting a load.

### BACKGROUND TO THE INVENTION

Lifting hooks for use with cranes or other machinery used for lifting loads are well known. Such hooks are used in a multitude of industries including construction and cargo handling. A typical hook has a hook member on which a lifting strop, sling, chain or other lifting/rigging equipment attached to a load to be lifted is placed. Once a lifting operation has been completed, an operator removes the strop or other lifting/rigging equipment from the hook member.

To avoid the requirement for an operator to manually remove lifting equipment from a hook, remotely operable hook assemblies are known. A remotely operable hook includes a mechanism to hold the hook in a closed position for lifting and actuate the hook to an open position to release the lifting equipment from the hook once a lifting operation has been completed. To ensure safe operation of a hook, the mechanism for opening the hook must not fail causing the hook to open inadvertently during a lifting operation. Such failure could result in serious damage to equipment or worse result in serious personal injury or a fatality.

U.S. Pat. No. 4,174,132 describes a remotely operable hook assembly. The hook assembly has a release mechanism comprising a locking member moveable to lock and release the hook member of the hook assembly. The locking member has a bearing face to bear on a corresponding face of the hook member to hold the hook member in the closed position. To ensure safe operation of the hook, the bearing face is bevelled so that a plane of the bearing face passes to the axis of rotation of the hook member, such that rotation of the hook in the open direction receives a force component acting in the direction of movement of the locking member necessary to engage the hook member to maintain the hook member in the closed position.

A remotely operable hook assembly can be limited in the maximum loading/weight the hook can lift by the assembly's remotely operable release mechanism. The remotely operable release mechanism must be robust enough to hold the hook in the closed position, but equally an actuator or the release mechanism must have sufficient power to release the hook member to allow the hook member to move to the open position.

A remotely operable hook may have many parts increasing manufacturing costs and maintenance requirements and introduce reliability issues.

Clutches or coupling mechanisms for use with hooks to couple a hook to a lifting point are known. A lifting point may not be adapted for direct lifting by a hook. Therefore, a clutch is used to engage the lifting point and provide an interface such as an eye or shackle that can be picked up by the hook.

Clutches may not be remotely operable requiring a person to release the clutch from a lifting point, thus defeating a main benefit of using a remotely operable hook. It is desirable to have a clutch that is remotely operable together with a remotely operable hook, to avoid the requirement for a separate release of the clutch from a lifting point. A clutch may not be positively coupled to a lifting point and may require load to be applied to the clutch to ensure the clutch is correctly coupled with the lifting point. This may require a person to be at the lifting point until load is taken up by the clutch.

### OBJECT OF THE INVENTION

It is an object of the invention to provide a lifting apparatus comprising a remotely operable hook and/or a clutch for use with a remotely operable hook that addresses the above-mentioned problems, or to at least provide the public with a useful choice.

### SUMMARY OF THE INVENTION

According to a first aspect of the invention, there is provided a clutch for use with lifting equipment for lifting a load with a lifting point, the clutch comprising:
a body,
a coupling to attach the body to the lifting equipment,
wherein the body has a cavity with an opening at a side of the body to receive the lifting point into the cavity,
a first lever and a second lever,
wherein the second lever is movably coupled to the body of the clutch to move between a close position and an open position, in the close position the second lever extends at least partially across the cavity of the body to block the cavity opening to capture the lifting point within the cavity, and in the open position the second lever is moved out of the cavity to unblock the opening to allow the lifting point to be passed into the cavity and out of the cavity via the cavity opening,
wherein the first lever is movably coupled to the body to move between an engaged position and a disengaged position, in the engaged position the first lever engages the second lever to maintain the second lever in the closed position, and in the disengaged position the second lever is disengaged from the second lever so that the second lever is free to move to the open position, and
a tensioning member, a proximal end of the tensioning member attached to the first lever and a distal end of the tension member adapted for attachment to the lifting equipment,
wherein with the lifting point captured in the cavity, and without application of a lifting force to the coupling, pulling the tensioning member:
   moves the first lever from the engaged position to the disengaged position to allow the second lever to move from the closed position to the open position, and
   rotates the clutch body relative to the lifting point to release the lifting point from the clutch body.

Pulling the tension member can rotate the clutch body relative to the lifting point to allow the clutch to be lifted away from the lifting point and release the lifting point from the clutch body.

In some embodiments, the first lever pivots about a pivot point to pivot relative to the body between the engaged and disengaged positions.

In some embodiments, the tensioning member is attached to a distal end of the first lever.

In some embodiments, the pivot point is located towards a side of the body opposite to the cavity opening, so that the lifting point is received in the cavity between the pivot point and the opening.

In some embodiments, the pivot point is located below a central axis of the head of the lifting point.

In some embodiments, the pivot point between the first lever and the body is positioned at or adjacent a proximal end of the first lever.

In some embodiments, the first lever comprises an engagement surface to engage a proximal end of the second lever.

In some embodiments, the engagement surface is located on the first lever between a distal end and a proximal end of the first lever, or between the tensioning member attachment to the first lever and a pivot point of the first lever on the body.

In some embodiments, the first lever comprises a cam surface to contact the second lever so that pressing the first lever against the second lever towards the engaged position causes the second lever to move to the close position.

In some embodiments, in the close position a distal end of the second lever extends at least partially across the cavity of the body to at least partially block the cavity opening.

In some embodiments, the second lever pivots about a pivot point to pivot relative to the body between the close and open positions.

In some embodiments, the pivot point for the second lever is located between a distal end and a proximal end of the second lever, so that the first lever has a first lever arm extending between the pivot point and the proximal end and a second lever arm extending between the pivot point and the distal end.

In some embodiments, the second lever is configured so that with the clutch body rotated to position the cavity opening downwards, the second lever is biased to the open position by gravity.

In some embodiments, the second lever is configured so that with the body rotated to position the lifting eye above the cavity, the second lever is biased to the close position by gravity.

In some embodiments, the clutch comprises a sprung detent to retain the first lever in the engaged position and therefore the second lever in the closed position.

In some embodiments, when the clutch is released from the lifting point the clutch hangs from the tensioning member and first lever.

In some embodiments, the clutch comprises:
the cavity configured to receive a head of a member of the lifting point, and a slot extending along the cavity with a closed end and an open end, wherein the open end of the slot is at the cavity opening so that the body is configured to capture the head in the cavity with the member of the lifting point passing through the slot,
wherein with the head captured in the cavity and the member of the lifting point at the closed end of the slot, pulling the tensioning member rotates the body relative to the lifting point to traverse the member of the lifting point along the slot to the cavity opening to allow the clutch to be lifted away from the lifting point and release the lifting point from the clutch body

In some embodiments, the clutch is configured to have a sideways load applied in a direction away from the cavity opening with the member of the lifting point bearing against a closed end of the slot to prevent the clutch body rotating relative to the lifting point.

In some embodiments, the cavity is a head slot extending fully across the body for receiving the head of the lifting point and the slot of claim 1 is a neck slot for receiving the member of the lifting point extending from the head such that the body comprises two spaced apart prongs to support the head of the lifting point during a lifting operation.

According to a second aspect of the invention, there is provided a clutch as described above in relation to the first aspect of the invention and a said lifting point, and the head of the lifting point is a ball, or the head is a cross member such that the lifting point comprises a T-shaped portion.

In some embodiments, the lifting point comprises a cross member extending between two side plates, and the cavity is a slot extending fully across the body for receiving the cross member, and the body of the clutch is sized to fit between the side members of the lifting point without a substantial gap between the body and each side member, so that the clutch is configured to have a sideways load applied orthogonal to the body of the clutch by the body bearing against the side members.

In some embodiments, the lifting point comprises:
two spaced apart side members,
the head is a first cross member extending between the two side members,
a second cross member extending between the side members, and
an elongate member or neck portion extending between the cross members,
such that the lifting point presents two apertures to receive the prongs of the clutch body with the head received in the head slot and the neck portion received in the neck slot.

In some embodiments, the body of the clutch is sized to fit between the side members of the lifting point without a substantial gap between the body and each side member, so that the clutch is configured to have a sideways load applied orthogonal to the body of the clutch by the body bearing against the side members.

The lifting point of the second and aspect may comprise an aperture opposite to the head for attaching a strop or lifting chain or the like.

According to a third aspect of the invention, there is provided a lifting point comprising:
two spaced apart side members,
a first cross member extending between the two side members,
a second cross member extending between the side members, and
an elongate member or neck portion extending between the cross members, such that the lifting point presents two apertures located between the side members and the first and second cross members and separated by the elongate member or neck portion.

According to a fourth aspect of the invention, there is provided a system for use with a lifting apparatus (such as a crane or the like with or without lifting equipment such as a lifting chain/strop/hook) for lifting a load with a lifting point, the system comprising:
a clutch for coupling the lifting apparatus to the lifting point, the clutch comprising a body for receiving the lifting point, a coupling to attach the clutch body to the lifting apparatus, a release member moveable relative to the clutch body to allow the clutch body to be released from the lifting point, and a tensioning member (i.e. a pull cord) attached to the clutch release member; and
the system characterised by:
a remotely operable tensioning mechanism configured to be attached between the lifting apparatus and the clutch tensioning member so that, in use, remote operation of the tensioning mechanism applies tension to the clutch tensioning member to move the clutch release member and release the clutch body from the lifting point.

In some embodiments, the remotely operable tensioning mechanism comprises an actuator, in use the actuator coupled to the clutch tensioning member, wherein the actuator is remotely operable to apply tension to the tensioning member.

In some embodiments, the remotely operable actuator comprises a spool and a remotely operable drive mechanism to rotate the spool, wherein the clutch tensioning member is coupled to the spool (i.e. wound onto the spool) so that rotation of the spool applies tension to the tensioning member. The remotely operable tensioning mechanism may comprise the clutch tensioning member.

In some embodiments, the remotely operable actuator comprises a actuator tensioning member wound onto the spool, in use the actuator tensioning member is coupled to the clutch tensioning member to couple the clutch tensioning member to the spool.

In some embodiments, the system comprises two or more said clutches for coupling the lifting apparatus to two or more corresponding said lifting points;
wherein the remotely operable tensioning mechanism is configured to be attached between the lifting apparatus and the clutch tensioning member of each said clutch so that, in use, remote operation of the tensioning mechanism applies tension to the clutch tensioning member of each said clutch to move the clutch release member and release the clutch body of each clutch from the respective lifting point.

In some embodiments, the remotely operable tensioning mechanism comprises an actuator and a lower coupling for coupling the clutch tensioning member of each said clutch to the actuator;
wherein the actuator is remotely operable to apply tension to the tensioning member of each said clutch to move the clutch release member and release the clutch body of each said clutch from the respective lifting point.

In some embodiments, the tensioning mechanism is configured to apply tension to the clutch tensioning members of the two or more clutches simultaneously.

According to a fifth aspect of the invention, there is provided a method for lifting a load comprising a lifting point, the method comprising:
coupling a clutch to the lifting point, the clutch attached to a lifting apparatus (such as a crane or the like), wherein the clutch comprises a body for receiving the lifting point, a coupling to attach the clutch body to the lifting apparatus, a release member moveable relative to the clutch body to allow the clutch body to be released from the lifting point, and a tensioning member (i.e. a pull cord) attached to the clutch release member;
attaching a remotely operable tensioning mechanism between the lifting apparatus and the clutch tensioning member, the remotely operable tensioning mechanism configured to apply tension to the clutch tensioning member upon receipt of a remote signal;
lifting the load with the lifting apparatus;
at the completion of lifting the load, removing tension from the clutch body coupling to set down the load and sending a signal to the remotely operable tensioning mechanism to apply tension to the clutch tensioning member to move the clutch release member and release the clutch body from the lifting point; and
moving the lifting apparatus away from the load.

In some embodiments, the remotely operable tensioning mechanism comprises an actuator, and the method comprises:
attaching the remotely operable tensioning mechanism between the lifting apparatus and the clutch tensioning member with the actuator coupled to the clutch tensioning member; and
at the completion of lifting the load, removing tension from the clutch body coupling to set down the load and sending a signal to the remotely operable tensioning mechanism to operate the actuator to apply tension to the clutch tensioning member.

In some embodiments, the remotely operable actuator comprises a spool and a remotely operable drive mechanism to rotate the spool, and the method comprises:
attaching the remotely operable tensioning mechanism between the lifting apparatus and the clutch tensioning member with the clutch tensioning member coupled to the spool;
at the completion of lifting the load, removing tension from the clutch body coupling to set down the load and sending a signal to the remotely operable tensioning mechanism to operate the drive mechanism and rotate the spool to apply tension to the clutch tensioning member.

In some embodiments, the remotely operable actuator comprises an actuator tensioning member wound onto the spool, and the method comprises:
attaching the remotely operable tensioning mechanism between the lifting apparatus and the clutch tensioning member with the actuator tensioning member coupled to the clutch tensioning member.

In some embodiments, the load comprises two or more lifting points and the method comprises:
coupling a said clutch to each said lifting point;
attaching said remotely operable tensioning mechanism between the lifting apparatus and the clutch tensioning member of each clutch; and
at the completion of lifting the load; removing tension from the clutch body coupling of each clutch to set down the load and sending a signal to the remotely operable tensioning mechanism to apply tension to the clutch tensioning member of each said clutch to move the clutch release member and release the clutch body of each clutch from the respective lifting point.

In some embodiments, the remotely operable tensioning mechanism comprises an actuator and a lower coupling for coupling the clutch tensioning member of each said clutch to the actuator, and the method comprises:
attaching the remotely operable tensioning mechanism between the lifting apparatus and the clutch tensioning members with the lower coupling coupled to the clutch tensioning member of each said clutch;
at the completion of lifting the load, removing tension from the clutch body coupling to set down the load and sending a signal to the remotely operable tensioning mechanism to operate the actuator to apply tension to the clutch tensioning member of each said clutch.

In some embodiments, the method comprises sending a signal to the remotely operable tensioning mechanism to operate the actuator to apply tension to the clutch tensioning members of the clutches simultaneously.

According to a sixth aspect of the invention, there is provided a remotely operable hook assembly for lifting a load, comprising:
a body,
a hook pivotally attached to the body to pivot between a closed position for lifting a load and an open position for releasing a load,
a remotely operable release mechanism comprising a remotely operable actuator and a locking member moveable between a locked position and an unlocked position, the actuator operable to allow the locking member to move from the locked position to the unlocked position upon receiving a signal,
a latch moveable between an engaged position and a disengaged position,
wherein with the latch in the engaged position and the locking member in the locked position, the locking member holds the latch in the engaged position to engage and hold the hook in the closed position, and with the locking member in the unlocked position, the latch is free to move to the disengaged position to disengage from the hook and allow the hook to move to the open position,
characterised in that:
with the hook in the closed position and the locking member in the locked position and the latch in the engaged position, a load applied to the hook forces the latch towards the disengaged position and against the locking member to cause a friction force against movement of the locking member, so that when the load is greater than a threshold the friction force prevents the release mechanism from moving the locking member to the unlocked position, thereby preventing the hook from moving to the open position during a lifting operation.

In some embodiments, the release mechanism comprises a spring providing a spring force to bias the locking member from the locked position to the unlocked position.

In some embodiments when the load is less than the threshold the spring force is greater than the friction force so that the spring moves the locking member to the unlocked position, and when the load is greater than the threshold the friction force is greater than the spring force to prevent the spring from moving the locking member to the unlocked position.

In some embodiments, the remotely operable release mechanism comprises a locking member latch moveable between an engaged position engaging the locking member to hold the locking member in the locked position and a disengaged position allowing the locking member to move to the unlocked position by action of the spring, and wherein the actuator moves the locking member latch from the engaged position to the disengaged position upon receiving the signal to allow the locking member to move from the locked position to the unlocked position.

In some embodiments, the locking member moves along its longitudinal axis between the locked and unlocked positions.

In some embodiments, the hook assembly further comprises a locking member support to support the locking member on an opposite side of the locking member to a contact between the locking member and the latch,
with the hook in the closed position and the locking member in the locked position and the latch in the engaged position, the locking member is captured between the member support and the latch with the member in compression and in a zero or near zero shear stress condition.

In some embodiments, in the unlocked position the locking member is disengaged from the latch.

In some embodiments, the latch is pivotally attached to the body to move between the engaged and disengaged positions.

In some embodiments, the locking member axis is parallel to the latch pivot axis.

In some embodiments, when viewed from a side of the hook assembly, the hook pivots in a clockwise direction to move from the close to the open position, and the latch pivots in an anti-clockwise direction from the engaged to the disengaged positions.

In some embodiments, the latch is biased by a spring towards the engaged position.

In some embodiments, the locking member axis is parallel to the hook pivot axis.

In some embodiments, the hook is provided with a first engagement surface and the latch is provided with a second engagement surface, the first and second engagement surfaces are in contact when the hook is in the closed position, and wherein the first and second engagement surfaces are arranged so that rotation of the hook about the hook pivot axis from the closed position to the open position forces the latch towards the disengaged position.

In some embodiments, when the locking member is in the unlocked position, the hook moves to the open position by gravity.

In some embodiments, the hook assembly further comprising a manual pull cord to allow an operator to manually pull the locking member to the unlocked position.

In some embodiments, the remotely operable release mechanism is a first remotely operable release mechanism and the hook assembly comprises the first remotely operable release mechanism and a second remotely operable release mechanism,
the first remotely operable release mechanism comprising a first remotely operable actuator and a first locking member moveable between a locked position and an unlocked position, the first actuator operable to allow the first locking member to move from the locked position to the unlocked position upon receiving a first signal; and
the second remotely operable release mechanism comprising a second remotely operable actuator and a second locking member moveable between a locked position and an unlocked position, the second actuator operable to allow the second locking member to move from the locked position to the unlocked position upon receiving a second signal;
wherein with the latch in the engaged position and the first and second locking members in the locked position, the first and second locking members hold the latch in the engaged position to engage and hold the hook in the closed position, and with the first and second locking members in the unlocked position, the latch is free to move to the disengaged position to disengage from the hook and allow the hook to move to the open position.

In some embodiments, the first remotely operable release mechanism is provided to a first side of the hook assembly and the second remotely operable release mechanism is provided to an opposite second side of the hook assembly.

In some embodiments, the first and second locking members move towards a centreline of the hook member when moving to the locked position and away from the centreline of the hook member when moving to the unlocked position, and wherein a gap between the ends of the locking members is centred on a centreline of the hook member.

According to a seventh aspect of the invention, there is provided a clutch for use with lifting equipment for lifting a load with a lifting point, the clutch comprising:
a body,
a coupling to attach the body to the lifting equipment,
wherein the body has a slot with an inverted U section for receiving the lifting point, the slot comprising a closed end, an exit section open through a lower portion of the clutch body, and a bend in the inverted U section between the closed end and the exit section,
an arm with a hooked end section, the arm movably coupled to the body to move between a first position and a second position, in the first position the hooked end section extending around the closed end of the slot and in the second position the hooked end section at or adjacent the bend in the inverted U section of the slot, and
a tensioning member, a proximal end of the tensioning member attached to the hook-shaped arm and a distal end of the tensioning member adapted for attachment to the lifting equipment,
wherein with the lifting point received at the closed end of the slot, pulling the tensioning member:
   moves the hook shaped arm from the first position to the second position to thereby move the clutch body relative to the lifting point to traverse the lifting point along the slot to beyond the bend in the slot to enter the exit section of the slot, and
   allow the clutch to be lifted away from the lifting point and release the lifting point from the clutch.

In some embodiments, the hook shaped arm moves in a linear or non-linear translation relative to the body.

In some embodiments, the arm is movably mounted to the body above the slot.

In some embodiments, the clutch comprises a lever pivotally coupled to the body via a pivot point to pivot between a closed position and an open position,
in the closed position, the lever at least partially closes or blocks the exit section of the slot to capture the lifting point in the slot between the lever and the closed end of the slot,
in the open position, the lever is pivoted out of the exit section of the slot so that the lifting point can pass along the exit section to release from the clutch.

In some embodiments, the tensioning member is attached to the lever so that the arm is moved from the first position to the second position and the lever is moved from the closed position to the open position by pulling the tensioning member.

In some embodiments, the tensioning member is attached to the lever and passes through an aperture in the arm, so that as the tensioning member is pulled, the tensioning member slides through the aperture as the lever is rotated from the closed position to or towards the open position.

In some embodiments, during rotation of the lever or once the lever is in the open position the lever engages the arm to move the arm relative to the body from the first position to or towards the second position as the tensioning member is pulled.

In some embodiments, the tensioning member comprises a stopper to prevent the tensioning member to continue to slide through the aperture and act on the arm to move the arm along the slot to the second position.

In some embodiments, in the closed position the lever engages an engagement surface of the arm to maintain the arm in the first position.

In some embodiments, when the arm is moved to or towards the second position, the arm engages the arm to maintain the arm in the second position.

In some embodiments, the lever rotates in a first direction around the pivot point to move from the closed position to the open position, and the lever and arm are configured so that with the lever in the closed position the lever engages or abuts the arm to prevent the lever rotating about the pivot point in a second opposite direction.

In some embodiments, the clutch comprises a sprung detent to retain the lever in the closed position.

In some embodiments, when the clutch is released from the lifting point the clutch hangs from the lever.

In some embodiments, when the clutch is released from the lifting point the clutch hangs from the arm.

According to an eighth aspect of the invention, there is provided the clutch as described in one or more of the above statements relating to the eighth aspect of the invention and a said lifting point,
the lifting point comprising a frame with two spaced apart sides and a lifting point member extending between the sides to be received in the slot of the clutch body, and wherein the body and frame are sized so that the body fits between the sides of the frame to receive the lifting point member in the slot without a substantial gap between the clutch body and each side of the frame, so that when an orthogonal lifting load is applied to the clutch the clutch body bears against the sides of the frame.

According to a ninth aspect of the invention, there is provided a remotely operable lifting apparatus, the apparatus comprising a remotely operable hook assembly as described in one or more of the above statements relating to the seventh aspect of the invention, and a clutch as described in one or more of the above statements relating to the first or eighth aspects of the invention, wherein the tensioning member is attached between the clutch and the hook assembly or lifting equipment associated with the hook.

In this specification and claims, where a lifting point is described as moving relative to a clutch body, for example along a slot of the clutch body, this is intended to be in a relative sense in which case the clutch may move relative to a stationary lifting point so that the lifting point travels along the slot.

In this specification and claims, where a lifting point is described as moving along a slot of the clutch body, this is intended to be in a relative sense. For example, a stationary lifting point ‘moves along the slot in the clutch’ by movement of the clutch relative to the stationary lifting point.

Terms such as above, below, front, rear etc are used in a relative sense only provided by way of explanation and are not intended to be limiting.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a schematic front view of a hook assembly for lifting a load with a crane or other lifting apparatus or machinery, with the hook in a closed position set for lifting a load;

FIG. 2 is a schematic side view of the hook assembly of FIG. 1 set for lifting a load;

FIG. 2A is a schematic side view of a hook assembly according to another embodiment;

FIG. 2B is a schematic representation of a transmitter for activating a hook assembly to allow a hook of the assembly to move from a closed position to an open position;

FIG. 3 is schematic front view of the hook assembly of FIG. 1 with the hook in an open position for releasing a load;

FIG. 4 is a schematic side view of the hook assembly of FIG. 1 in an open position for releasing a load;

FIG. 5 is a schematic view of a pair of clutches and hooks lifting a load;

FIGS. 6 & 7A are schematic views of a clutch for lifting a load with a hook;

FIG. 7B shows the clutch of FIGS. 6 and 7A being released from the hook and being operated to release a load lifting point from the clutch;

FIG. 7C shows the clutch of FIGS. 6 and 7A being lifted off the lifting point to release the lifting point from the clutch;

FIG. 8 shows an example lifting point that may be used with the clutch of FIGS. 6 to 7C, including various lifting points with alternative bases for embedding in concrete;

FIG. 8A shows the clutch of FIGS. 6 and 7A attached to a lifting point of a concrete panel prior to lifting the panel from a horizontal orientation to a vertical orientation;

FIG. 9A is a side view of another clutch for lifting a load;

FIG. 9B is a front side view of the clutch of FIG. 9A;

FIG. 9C is a rear side view of the clutch of FIG. 9A;

FIGS. 10 & 11A are schematic views of the clutch of FIGS. 9A to 9C;

FIGS. 11B & 11C show the clutch of FIGS. 10 and 11A being released from the hook and being operated to release a load lifting point from the clutch;

FIG. 11D shows the clutch of FIGS. 10 and 11A being lifted off the lifting point to release the lifting point from the clutch;

FIG. 12 shows the clutch of FIGS. 10 and 11A being coupled to a lifting point;

FIG. 13 shows example lifting points that may be used with the clutch of FIGS. 10 to 12 with alternative bases for embedding in concrete;

FIGS. 14A to 14C show the clutch as described with reference to FIGS. 9A to 12, with the clutch coupled to a lifting point. A lifting eye of the clutch is only partly shown. FIG. 14A is a side view. FIG. 14B is a front side view. FIG. 14C is a sectional view on line A-A in FIG. 14B.

FIGS. 15A to 15C show the clutch of FIGS. 14A to 14C and lifting point but with the lifting point released from the clutch. FIG. 15A is a side view. FIG. 15B is a front side view. FIG. 15C is a sectional view on line B-B in FIG. 15B.

FIGS. 16A to 16C illustrate another clutch for lifting a load. FIG. 16A is a side view, FIG. 16B is a front side view, and FIG. 16C is a rear side view.

FIGS. 17A to 17C show the clutch of FIGS. 16A to 16C coupled to a lifting point. A lifting eye of the clutch is only partly shown. FIG. 17A is a side view. FIG. 17B is front side view.

FIG. 17C is a sectional view on line C-C in FIG. 17B.

FIGS. 18A to 18C show the clutch and lifting point of FIGS. 17A to 17C but with the lifting point released from the clutch. FIG. 18A is a view. FIG. 18B is a front side view. FIG. 18C is a sectional view on line D-D in FIG. 18B.

FIG. 19 is an isometric view of the clutch of FIGS. 9A to 9C FIG. 20 is an isometric view of the clutch of FIGS. 16A to 16C.

FIG. 21 is an isometric view of another clutch for lifting a load.

FIG. 22 shows a load with a lifting point like those of FIG. 13 fitted to the load;

FIG. 23 is a schematic view of a system for lifting a load comprising the clutch of Figure and a remotely operable tensioning mechanism operable to release the clutch from a lifting point.

FIG. 24 is a schematic view of a system for lifting a load comprising a pair of clutches as shown in FIG. 5 and a remotely operable tensioning mechanism operable to release the clutches from corresponding lifting points.

### BRIEF DESCRIPTION OF PREFERRED EMBODIMENTS OF THE INVENTION

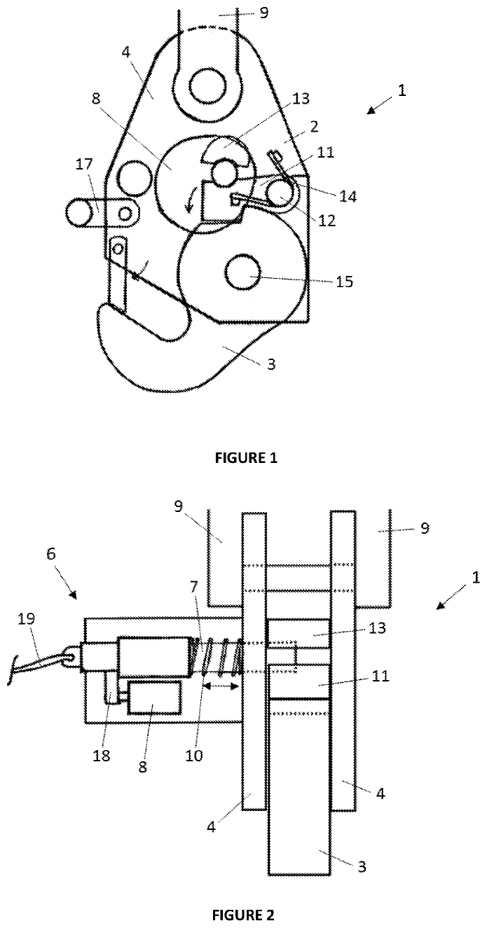

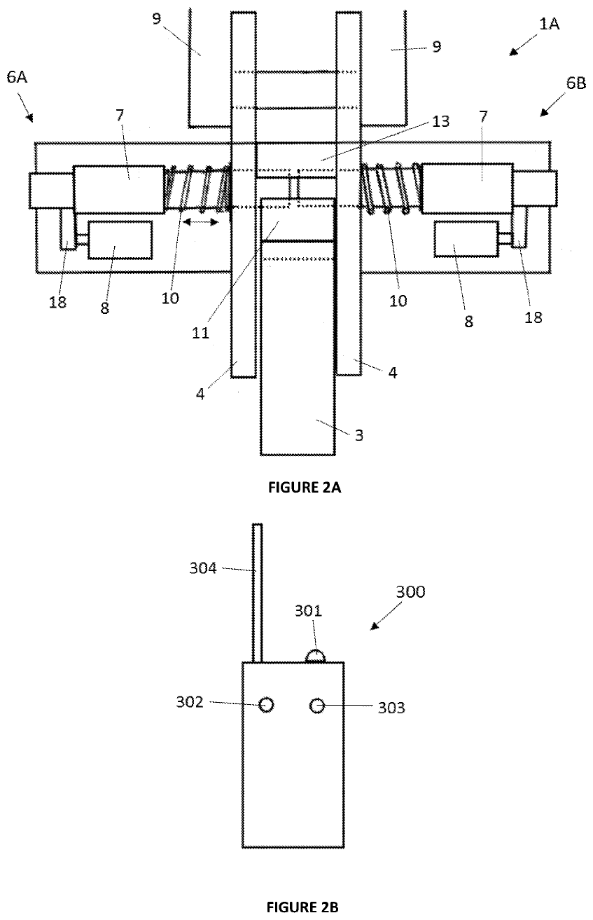

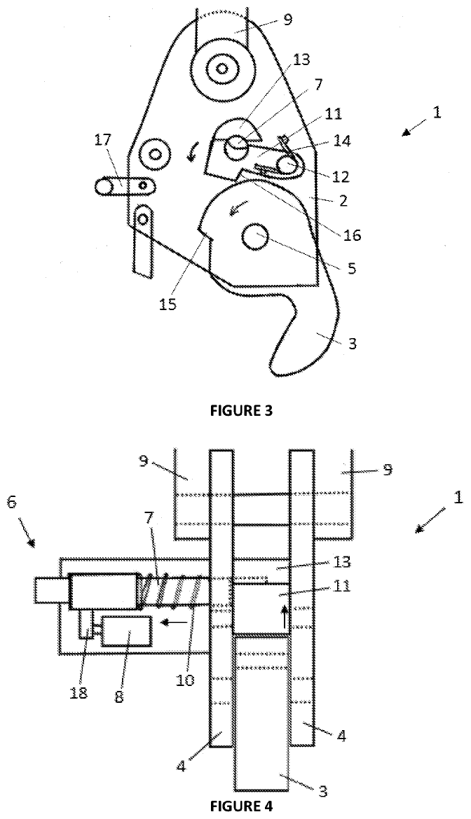

FIGS. 1 to 4 provide schematic representations of a remotely operable hook assembly 1. The hook assembly 1 is attached to a lifting apparatus or machine such as a crane in use and is adapted for lifting heavy loads, for example precast concrete panels. FIGS. 1 and 2 show the hook assembly 1 in a locked and closed position for lifting a load and FIGS. 3 and 4 show the hook assembly 1 in an unlocked and open position to release a load.

The hook assembly 1 has a body or frame 2 and a hook 3 is pivotally attached to the body. The body may comprise two plates 4 spaced apart and held together by a number of pins or may be otherwise constructed, for example machined from a block. The hook 3 is mounted to the body 2 on a pivot pin 5 and pivots on the body 2 about a pivot axis to move between the closed and open positions. In the illustrated embodiment the hook 3 is received between the two spaced apart plates 4 of the body. A shackle 9 or other lifting component may be fitted to the body to attach the hook assembly 1 to a crane or other equipment.

The hook assembly 1 is configured to be operated/actuated remotely to move from the closed position to the open position to release a load. For example, once the hook 3 has been actuated to the open position, lifting equipment such as a strop or chain is released from the hook 3.

The hook assembly 1 comprises a remotely operable release mechanism 6 (FIGS. 2 and 4) to allow the hook 3 to move from the closed position to the open position. In one embodiment the mechanism 6 is remotely operated by a coded digital UHF radio signal, however an alternative known remote communication signal may be used, whether wireless or via hardwired cable connected between the mechanism 6 and a remote location.

The release mechanism 6 comprises a locking pin 7 and an actuator 8 such as a motor or other actuator. The actuator allows the locking pin to move between a locked position shown in FIGS. 1 and 2 and an unlocked position shown in FIGS. 3 and 4 upon receiving a remote signal. The pin 7 moves along its longitudinal axis between the locked and unlocked positions. In one embodiment, the release mechanism comprises a spring 10 to provide a spring force to bias the locking pin 7 away from the locked position and towards the unlocked position, to move the pin 7 from the locked position to the unlocked position. On command by a remote signal, the actuator 8 is activated to enable the locking pin 7 to retract from the locked position to the unlocked position. A bias force by spring 10 in the unlocked direction causes the pin 7 to retract to the unlocked position once the mechanism 6 is actuated to retract the pin 7. In the illustrated embodiment the remotely operable release mechanism 6 has a locking member latch 18. The latch 18 acts on the locking member/pin 7 to hold the locking pin in the locked position against the bias force provided by the spring 10. For example, as shown in FIG. 2 the latch 18 acts against a shoulder (e.g. an annular shoulder) on the locking pin 7. To release the locking pin the actuator 8 drives the latch 18 to disengage from the locking pin to allow the locking pin to move from the locked position to the unlocked position under action of the spring 10 as shown in FIG. 4. The locking pin 7 has an enlarged diameter section presenting an annular shoulder towards the spring for the spring to act on and an opposite annular shoulder against which the latch can act on. In the illustrated embodiment the actuator 8 is a rotary motor to drive the latch by rotation between an engaged position engaging the pin to hold the pin in the locked position and a disengaged position allowing the pin to move to the unlocked position. Since the actuator latch 18 acts on the pin against the spring bias only, and not directly on the main latch 11 holding the hold in the closed position, the size/power of the actuator 8 may be reduced.

One example remotely operable mechanism 6 is a Fortronics™ remote actuator, provided in Fortronics™ electronic choker systems used in the forestry industry for hauling logs.

The hook assembly 1 comprises a latch 11 between the hook 3 and the locking pin 7. In the closed position the locking pin 7 engages the latch 11 to act on the latch and hold the latch 11 in an engaged position shown in FIGS. 1 and 2. In the engaged position, the latch 11 engages the hook 3 to act on and hold the hook 3 in the closed position. In the closed position the hook 3 is positioned for lifting a load. The load is transmitted to the hook body 2 via the latch 11 and locking pin 7.

A locking pin support 13 is provided to support the locking pin 7 on an opposite side to contact between the locking pin 7 and the latch 11. The locking pin support 13 is provided on the body 2 of the hook assembly. In the illustrated embodiment the support 13 is provided between the two spaced apart plates 4 of the body 2. In the engaged position, the latch 11 engages the hook 3 to hold the hook 3 in the closed position. In the closed position the hook 3 is positioned for lifting a load. The load is transmitted to the hook body 2 via the latch 11 and locking pin 7 to the body 2 via the locking pin support 13. The locking pin 7 is captured between the latch 11 and the locking pin support 13 so that the pin 7 is in compression. The locking pin 7 is placed in compression and in a zero or near zero shear stress condition. This arrangement configures the hook assembly 1 for lifting heavy loads. In one embodiment, the hook assembly 1 is adapted for lifting loads in excess of 20 tonne, or 30 tonne, or 40 tonne.

To move the hook 3 to the open position to release a load, the release mechanism 6 is actuated to move the pin 7 or allow the pin 7 to move from the locked position to the unlocked position. In the unlocked position the pin 7 is disengaged from the latch 11. When disengaged from the latch 11 the pin 7 is out of contact with the latch 11. With the pin 7 in the disengaged position the latch 11 can move from the engaged position to the disengaged position to allow the hook 3 to move from the closed position to the open position.

The latch 11 is pivotally attached to the hook assembly body on a pivot pin 12. With the pin 7 in the unlocked position the latch 11 can pivot between the engaged and disengaged positions. In one embodiment, the latch is biased by a spring 14 towards the engaged position in engagement with the hook 3.

In the illustrated embodiment, the locking pin 7 axis is parallel to the hook 3 pivot axis. The locking pin 7 axis is parallel to the latch 11 pivot axis. The latch 11 pivot axis is parallel to the hook 3 pivot axis. In the illustrated embodiment, the hook 3 pivot axis is located horizontally between the latch 11 pivot axis and the locking pin 7 pivot axis. The latch 11 pivot axis is located vertically between the locking pin 7 axis and the hook 3 pivot axis.

As best shown in FIG. 3, the hook 3 is provided with a first engagement surface 15 and the latch 11 is provided with a second engagement surface 16. The first and second engagement surfaces 15, 16 are in contact when the hook is in the closed position. The first and second engagement surfaces 15, 16 are arranged so that rotation of the hook 3 about the hook pivot axis from the closed position to the open position forces the latch 11 against the direction of the latch bias towards and against the locking pin 7. The first and second engagement surfaces 15, 16 are arranged so that rotation of the hook 3 about the hook pivot axis from the closed position to the open position forces the latch towards the disengaged position, i.e. out of contact with the hook member. The higher the load applied to the hook 3, the higher the force applied by the hook 3 to the latch 11, and in turn from the latch 11 to the locking pin 3. When viewed from one side of the assembly 1, the hook pivots in a clockwise (or anticlockwise) direction to move from the close to the open position and the latch pivots in the opposite anticlockwise (or clockwise) direction to move from the engaged to the disengaged positions.

In the illustrated embodiment, the first and second engagement surfaces are angled so that rotation of the hook 3 about the hook pivot axis from the closed position to the open position forces the latch 11 against the locking pin when the locking pin is in the locked position preventing the latch from moving out of engagement with the hook. The first and second engagement surface act as cam surfaces, so that rotation of the hook in the open direction drives rotation of the latch against the locking pin.

The hook assembly 1 is configured so that the hook assembly 1 cannot be actuated from the closed position to the open position under load. To open the hook assembly 1, an operator removes the weight of the load from the hook by lowering the load to a ground or other support surface. With no load on the hook 1, the release mechanism 6 may be actuated to allow the pin 7 to move from the locked position to the unlocked position. Once the pin is in the unlocked position, the weight of the hook 3 overcomes the spring bias of the latch 11, to allow the hook 3 to move from the closed position to the open position.

The hook assembly is importantly configured so that the hook cannot move from the closed position to the open position with load applied to the hook. With load applied to the hook assembly 1, the hook 3 applies a force to the latch 11 to press the latch 11 against the locking pin 7. The locking pin 7 is placed in compression between the latch 11 and the locking pin support 13. Friction between the locking pin 7 and the latch 11 and between the locking pin 7 and the support surface 13 holds the locking pin 7 in the locked position to maintain the latch 11 engaged with the hook 3 and retain the hook 3 in the closed position. Even if an operator inadvertently sends a remote signal to the hook assembly actuator 6 to actuate the hook to the open position during a lifting operation, the hook will remain in the closed position due to friction between the locking pin 3 and the latch 11 and locking pin support 13.

Once load is removed from the hook, the force applied by the hook 3 to the latch 11 and in turn the force applied from the latch 11 to the locking pin 7 resulting from the load is removed. With no load applied to the hook, the spring bias of the locking pin 7 overcomes a friction force between the locking pin 7 and the support surface 13 and the locking pin 7 and the latch 11 resulting from the weight of the hook, and the locking pin 7 is retracted to the unlocked position out of engagement with the latch 11 by the locking pin spring 10. With the locking pin 7 out of engagement with the latch 11, the weight of the hook 3 overcomes the spring bias of the latch 11 so that the hook moves by gravity to the open position, forcing the latch 11 to the disengaged position. In the disengaged position the second engagement surface 16 of the latch is disengaged from the first engagement surface 15 of the hook 3.

Thus, the hook 3 cannot move when a load lifted by the hook assembly 1 results in a friction force on the locking pin 7 that is more than the spring bias provided by the locking pin spring 10. Thus, the bias of the locking pin spring 10 determines a minimum load condition under which the hook 1 can be actuated to the open position. In one embodiment, the locking pin spring bias is 17 kg, however any desired spring bias may be provided for an intended loading requirement.

When load is applied to the hook assembly 1, the hook 3 forces the latch 11 against the locking pin 7, so that friction prevents the locking pin retracting, even when the mechanism is actuated to allow the locking pin 7 to move to the unlocked position. When load is released from the hook, the force between the latch 11 and the pin 7 is reduced. Furthermore, with no load on the hook 3, the bias of the latch 11 towards the hook 3 further reduces contact friction between the latch 11 and the locking pin 7. This double action ensures the locking pin 7 will retract under action of the locking pin spring 10 bias effecting a quick release time.

In some embodiments, the hook assembly 1 is provided with a manual pull cord (19, FIG. 2) to allow an operator to manually pull the locking pin 7 to the retracted unlocked position. An operator may send a remote signal to the release mechanism to release the pin, however should the pin remain in the locking position an operator can pull the pin to the unlocked position using the pull cord 19. Alternatively, the remotely operable release mechanism may include an override mechanism to allow an operator to manually pull the locking pin via the pull cord to the unlocked position without sending a signal to operate the actuator 8.

When the hook assembly is in the open position, an operator manually rotates the hook 3 from the open position to the closed position, for example once a lifting strop or chain or other lifting equipment is placed on the hook 3. The latch is biased towards the hook, so that the latch rides over the hook 3 as the hook is rotated to the closed position, until the latch snaps into place in the engagement position once the hook reaches the closed position under action of the latch spring 14. With the latch in the engaged position, an operator may remotely signal the release mechanism to move the locking pin to the locked position. This sets the hook assembly 1 in the closed position ready for a lifting operation.

A hook assembly according to one or more embodiments includes one or more of the following benefits:
The hook assembly is particularly adapted for lifting heavy loads since the locking pin is in compression and can therefore withstand high loads.
The hook assembly will only release in a no load or near no load situation as determined by the locking pin spring bias.
The hook assembly is mechanically adapted to avoid inadvertent actuation from the close position to the open position during a lifting operation, improving safety. Safety is not dependent on reliability of electronic components/actuator.
Even though the locking pin is biased to the unlocked position, safety during a lifting operation is achieved by the friction override provided by the arrangement of the hook, latch and locking pin interaction.
The hook assembly is simple with few moving parts.
The locking pin is driven to the unlocked position by a spring, not an actuator, so that the locking pin retracts rapidly to the unlocked position.
Rapid and reliable opening of the hook is achieved by the spring bias of the locking pin and the hook opening by gravity under its own weight.
A manual release option may be provided in case of a malfunction of the remote signal release.

An alternative embodiment is shown in FIG. 2A. The embodiment 1A of FIG. 2A comprises a first remotely operable release mechanism 6A and a second remotely operable release mechanism 6B. The first and second release mechanisms 6A, 6B may be as described above with reference to FIGS. 1 to 4. The first and second release mechanisms may be identical.

The first and second release mechanisms are arranged so that the locking pin 7 of each release mechanism 6A, 6B acts on the latch 11 when in the locked position (shown in FIG. 2A). For example, as illustrated, the first release mechanism is provided to one side plate 4 and the second release mechanism is provided to the other side plate 4. The locking pin of each release mechanism moves towards a centreline of the hook member 3 when moving to the locked position and moves away from the centreline of the hook member 3 when moving to the unlocked position. A small gap may be present between ends of the locking pins 7 when both locking pins are in the locked position. The locking pins are centred about the centreline of the hook member, i.e. are the same distance from the centreline of the hook. In the illustrated embodiment the longitudinal axis of the locking pins are aligned, however in other embodiments the locking pins may be side by side.

Providing two release mechanisms as described provides a number of further benefits. In the locked position, each locking mechanism extends for a portion of the width of the hook member, rather than a full width of the hook member. This reduces the force to move the pin to the unlocked position, since the friction between the pin 7 and latch 11 is reduced compared to if the pin extends the full width of the hook member. This results in the actuator 8 and spring being lighter than would otherwise be required. Furthermore, a balanced mechanical arrangement is maintained by having a pin act on the latch from each side. The gap between the pin ends is preferably centred on the hook member 3. Balanced loading of the latch 11 and hook member 3 is preferred, especially for high tonnage hooks, e.g. in excess of 20 tonnes. Having two locking pins also provides redundancy where one pin is sufficiently sized to secure the hook in the closed position.

Having two release mechanisms 6A, 6B also provides for greater control and prevention of false release activations. While the first and second release mechanisms 6A, 6B may be mechanically and electrically the same, each may be activated by a unique signal/code. Therefore, to release the hook a transmitter must provide two unique codes. A transmitter may have a first control input (e.g. a button) for an operator to activate to release the locking pin 7 of the first release mechanism 6A and a second control input (e.g. a button) for an operator to activate to release the locking pin 7 of the second release mechanism 6B. This eliminates the possibility of a single button operation accidentally actuating the hook member to the open position and inadvertent dropping of a heavy load.

Additional control inputs may be required. For example, with reference to FIG. 2B, a transmitter 300 such as a radio frequency transmitter may have a first button 301 to power the transmitter, a second button 302 to operate the first release mechanism 6A, and a third button 303 to operate the second release mechanism 6B. An operator may be required to hold down the power button 301 and the second button 302 to release the first release mechanism and hold down the power button 301 and the third button 302 to release the second release mechanism. The illustrated transmitter 300 is a handheld transmitter with an antenna 304 for sending wireless signals to the release mechanism(s).

First Clutch Mechanism

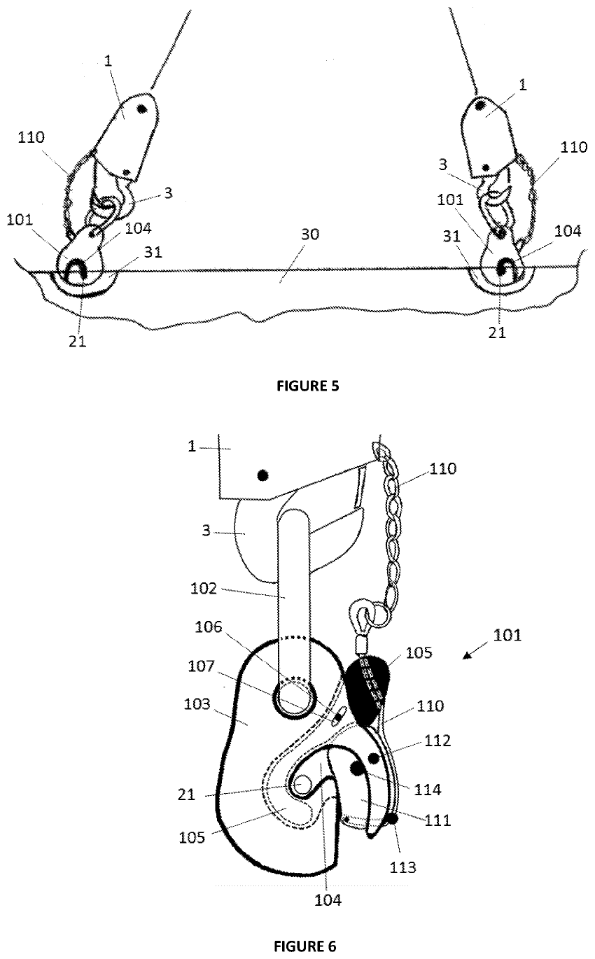

A clutch mechanism or coupling device (herein a clutch) for use with a remotely operable hook assembly is shown in FIG. 6. The clutch 101 may be used with the hook assembly 1 described above with reference to FIGS. 1 to 4, or any other hook assembly or lifting equipment together with a remotely operable tensioning mechanism, as described in more detail below.

FIG. 5 shows the clutch 101 of FIG. 6 used with the hook 1 of FIGS. 1 to 4 to couple the hook to a load to lift the load 30. A pair of clutches 101 and hooks 1 are shown in FIG. 5 to lift the load 30. The load may be a concrete panel or other panel or may be any object that requires lifting.

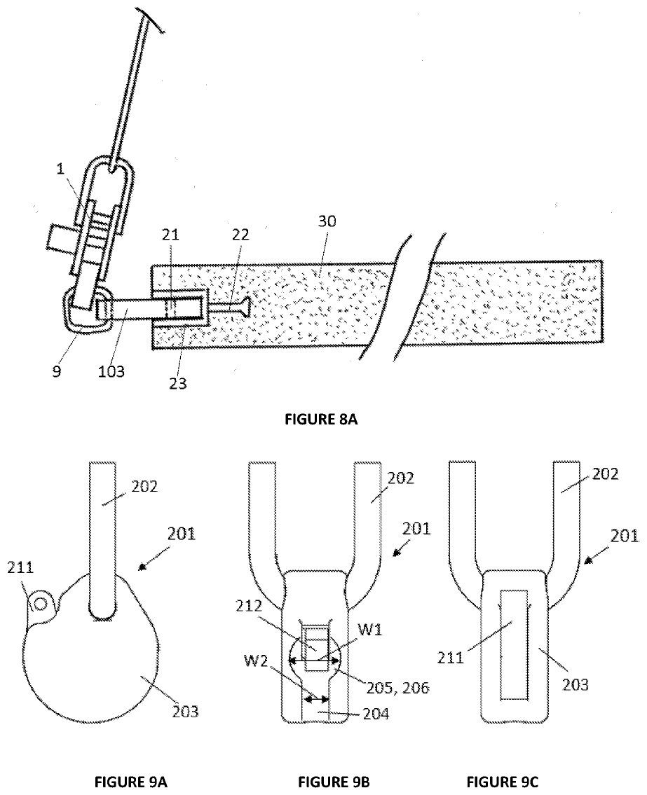

FIG. 6 shows the clutch 101 attached to or coupled with a lifting point. The lifting point comprises a bar or member 21. Example lifting points 20 are shown in FIG. 8. As shown in FIG. 8, the lifting point 20 comprise a frame 23 comprising two spaced apart members to support the member 21 between, and a base 22 for fixing the lifting point 20 to an object to be lifted. The illustrated lifting points are particularly adapted for use with a concrete panel. The base of the lifting point is embedded in a concrete panel during manufacture of the concrete panel, for example by embedding in poured concrete prior to the concrete of the panel setting. In the finished panel the lifting point may be recessed in a recess 31. The recess and lifting point may be provided to an edge of the panel 30 for lifting the panel in a vertical orientation as shown in FIG. 5. The clutch may be used to lift a load via any lifting point comprising a bar section, such as a shackle or eye with a portion to be received in a slot of the clutch, as now described. The bar section may be curved, e.g. the lifting point may comprise an annular ring with a portion of the ring to be received in the clutch.

To lift a load, the clutch is coupled to the lifting point 20 and the clutch is attached to the hook 1 via lifting eye 102. The hook is lifted by crane or other lifting apparatus, with the weight of the load taken by the clutch and hook.

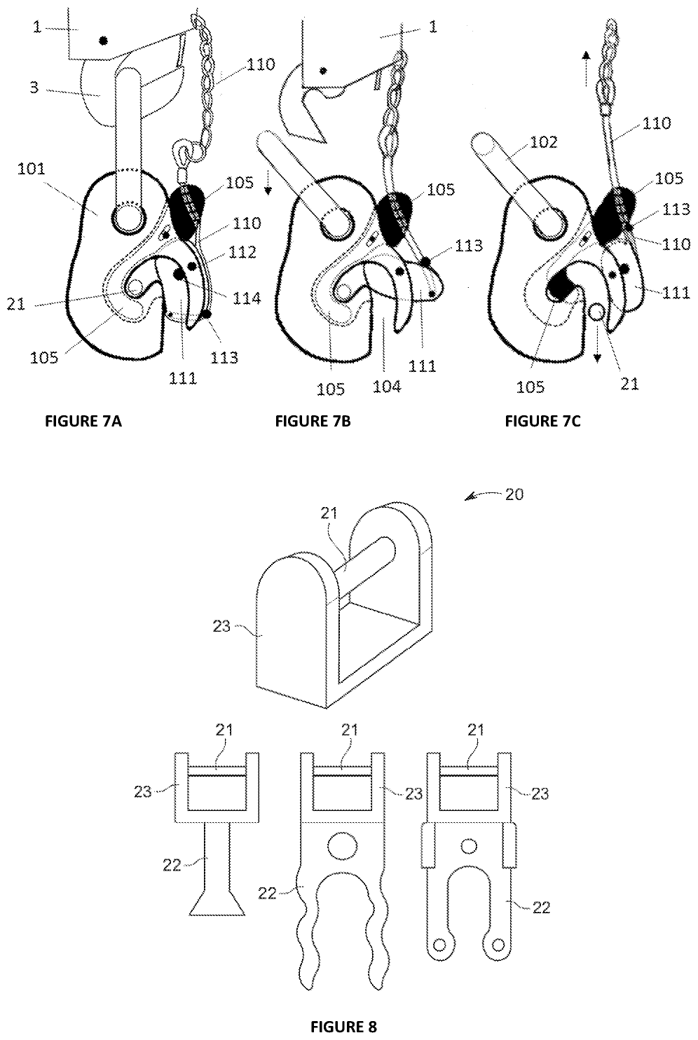

The clutch 101 has a body 103 and a lifting eye 102 or other coupling for attaching the body to the hook. The body has a slot 104 to engage the lifting point member 21. The slot comprises a section that is approximately an ‘inverted U-shape’ or an ‘upside-down J-shape’, herein referred to as an inverted U-shape or U-section. When lifting a panel, the lifting point 21 is received/seated in a closed end of the slot 104 beyond a bend in the inverted U section of the slot. In a lifted position with the lifting member hanging from the clutch the lifting point member 21 extends through the slot. The lifting point member 21 extends laterally across the slot 104. An opposite end of the slot is open through a lower section of the body 104. To exit the slot to be released from the clutch 101, the lifting point 21 must travel upwards along the slot 104 from the closed end to the bend in the inverted U section, pass over the bend in the inverted U section, and travel downwards through the exit section of the slot to the open end of the slot. The exit section of the slot is the portion of the slot between the bend of the inverted U section and the open end of the slot. In some embodiments the exit section of the slot may be substantially vertical. FIGS. 6 and 7A show the clutch 101 lifting the lifting point 21 with the lifting point captured at the closed end of the slot.

The clutch comprises a hook-shaped arm 105. The hook shaped arm is movably coupled to the body of the clutch to move between a first position and a second position. The hook shaped arm moves in a linear or non-linear translation relative to the body (i.e. the arm does not rotate or pivot on a pivot point). The arm is movably mounted to the body above the slot 104. During a lifting operation with the lifting point 21 received in the closed end of the slot 104 the hooked shaped arm 105 is in the first position with a hooked end section of the arm 105 received around the lifting point 21 and an end of the slot, as shown in FIGS. 6 and 7A.

The arm 105 is a release member movable relative to the clutch body to release the lifting point from the clutch body. To release the lifting point 21 from the clutch 101, the hook shaped arm 105 is moved relative to the body 101 and therefore the slot 104 from the first position to the second position shown in FIG. 7C with a hooked section of the arm at or adjacent the bend of the inverted U section of the slot. As the arm 105 moves along the slot 104 the hooked end of the arm 105 pushes/moves the lifting point 21 along the slot to beyond the bend in the inverted U section to enter the exit section of the slot. Once in the exit section of the slot, the clutch can be lifted away from the lifting point 21 so that the lifting point exits the slot 104 to be released from the clutch.

In the illustrated embodiment the arm 105 is movably coupled to the body 103 via a pin 106 projecting from the arm 105 or body 103 and received in a slot 107 in the body 103 or arm 105. The slot 107 may be linear/straight or may be non-linear/curved to achieve a desired movement of the arm 105 along the slot 104.

The clutch 101 is adapted for remote operation by a pull cord 110 attached between the arm 105 of the clutch and the hook 1 or crane or other lifting equipment attached to the hook 1. A proximal end of the pull cord is attached to the arm and a distal end is attached to the hook or lifting equipment to which the hook is attached, for example attached to a lifting strop or chain extending between a hook and the clutch. In the illustrated embodiment, the pull cord is attached to the body of the above described hook assembly 1, for example via attachment point 17 shown in FIGS. 1 and 3. The pull cord may comprise a chain, a cord, cable or any other (preferably flexible) tensioning member. The pull cord 110 is attached to an opposite/distal end of the arm 105 to the hooked (end) section of the arm.

Once a lifting operation has been completed an operator lowers the hook, clutch and load until the weight of the load is supported by a ground or other surface to remove the weight of the load from the hook 1 and clutch 101. The operator then remotely operates the hook assembly 1 to release the clutch body 103 from the hook assembly 1. For example, the operator actuates the remotely operable hook assembly 1 to release the lifting eye 102 of the clutch 101 from the hook 3 of the hook assembly 1. The lifting eye 102 may fall or drop to one side of the clutch body, as shown in FIG. 7B.

The operator then moves the hook away from the clutch 101, with the clutch 101 remaining coupled to the load 30 via the lifting point 21 captured in the closed end of the slot 104 of the clutch. This tensions the pull cord as shown in FIG. 7B. As the crane or other lifting equipment continues to move away from the load, the pull cord moves the arm 105 along the slot 104 so that the hooked end of the arm engages the lifting point to move the clutch body relative to the lifting point so that the lifting point is moved along the slot to beyond the bend of the inverted U section of the slot. The lifting point enters the exit section of the slot, and the arm reaches an end of travel relative to the clutch body, so that as the crane or other lifting equipment continues to move away from the load/lifting point, the clutch is lifted off the lifting point via the pull cord, with the lifting point 21 travelling along the exit section of the slot 104 and out of the slot 104 of the clutch body 103, as shown in FIG. 7C. Once the lifting point has been released from the clutch, the clutch hangs from the hook assembly 1 via the pull cord 110.

The clutch comprising the body with inverted U-shaped slot, hooked arm and pull cord, when used together with a remotely operated hook, allows for a load to be remotely released from the lifting equipment. An operator is not required to enter an unsafe area to uncouple the lifting equipment from the load.

The illustrated embodiment further comprises a lever 111 pivotally coupled to the body 103 via a pivot point 112. The lever 111 pivots between a closed position and an open position. In the closed position, as shown in FIGS. 6 and 7A, the lever at least partially closes or blocks the exit section of the slot 104, to capture the lifting point in the slot between the lever 111 and the closed end of the slot 104. In the open position the lever 111 is pivoted out of the exit section of the slot so that the lifting point can pass along the exit section to release from the clutch, as shown in FIG. 7C and described above.

The lever 111 is also coupled to the pull cord so that the lever and arm are both operated by the crane or other lifting equipment moving away from the clutch body. The lever therefore may also be considered a release member moveable relative to the clutch body to release the lifting point from the clutch body. As the crane or other lifting equipment moves away from the clutch body, the pull cord is tensioned to rotate the lever to move the lever from the close position to the open position, and move the arm 105 to shift the lifting point 21 from the closed end of the slot 104 beyond the bend in the inverted U section of the slot to the exit section of the slot. As the crane continues to move away from the lifting point the clutch is lifted away from the lifting point, with the lifting point passing along the slot to be released from the clutch.

In the illustrated embodiment, the pull cord is attached to the lever 111 and passes through a slot/aperture in the arm 105. As the cord 110 is pulled, the cord slides through the arm aperture as the lever is rotated from the closed position to or towards the open position. During rotation of the lever or once the lever is in the open position the lever may engage the arm 105 to move the arm relative to the body 103 as the cord is pulled further, to move the lifting point from the closed end to the exit section of the slot 104. Additionally, or alternatively, the pull cord may comprise a stopper 113 to prevent the pull cord from continuing to pass through the arm aperture and act on the arm to move the arm along the slot 104.

In some embodiments, the lever engages the arm when the lever is in the closed position to maintain the arm in the first position, so that the arm cannot move out of the first position. The pull cord moves the lever from the closed position towards the open position to disengage the lever from the arm to allow the arm to be moved by the pull cord from the first position to the second position. In some embodiments, in the closed position a first end of the lever engages an engagement surface of the arm to maintain the arm in the first position. When the arm is moved to or towards the second position, a second opposite end of the arm engages the engagement surface of the arm to maintain the arm in the second position.

The lever rotates in a first direction around the pivot point 112 to move from the closed position to the open position. In the closed position the lever 111 and arm 105 may be configured so that the lever engages or abuts the arm to prevent the lever rotating about the pivot point 112 in a second direction opposite to the first direction, so that the lifting point 21 cannot knock the lever 105 out of the closed position when the clutch is coupled to the lifting point but with no load applied (i.e. coupled to but prior to lifting a load). FIGS. 6 and 7A show the lever engaged with the arm to prevent the lever rotating clockwise.

Additionally, or alternatively, the clutch may comprise a biased detent to help retain the lever in the closed position or to require a certain force to move the lever out of the closed position. The illustrated embodiment comprises a sprung projection 114 on the lever, such as a sprung ball bearing, that acts against a corresponding surface of the cutch body. The detent 114 must be depressed to allow the lever to move out of the closed position.

To couple the clutch to the lifting point, an operator places the clutch over the lifting point so that the lifting point enters the slot 104. The operator moves the arm to allow the lifting point to reach the closed end of the slot, and rotates the lever to the closed position, to capture the lifting point in the slot. The hook is then coupled to the clutch body, for example via the clutch lifting eye. If not already attached the operator attaches the pull cord between the arm and the hook 1 for subsequent release of the clutch. The crane or other lifting equipment can then lift the load via the lifting point 21, clutch 101 and hook assembly 1.

The clutch 101 when used together with the lifting point 20 may be used to lift an object such as a concrete panel from an initial orientation (horizontal panel) in which the lifting point member 21 is vertical to a lifted orientation (vertical panel) in which the lifting point member 21 is horizontal with the lifted object hanging from the clutch. The body 103 of the clutch is sized to fit between the side members of the frame 23 of the lifting point 20 without a substantial gap between the body 103 and each side member of the frame 23 of the lifting point, as shown in FIG. 8A. For example, a clearance fit may be provided for the body 103 within the frame 23. The fit of the body within the lifting point frame allows the body to bear against the side members of the frame when a lifting force is provided orthogonal to the clutch body as shown in FIG. 8A. As the object is lifted from the initial orientation to a lifted orientation, the object and lifting point may be rotated until the clutch body is vertical and the lifting point member 21 is horizontal. Side loading is applied by the clutch body 103 to the lifting point frame 23. This arrangement may be particularly useful for lifting panels/planar members from a horizontal orientation to a vertical orientation, for example when tilting up concrete panels from horizontal to vertical when constructing a building.

Second Clutch Mechanism

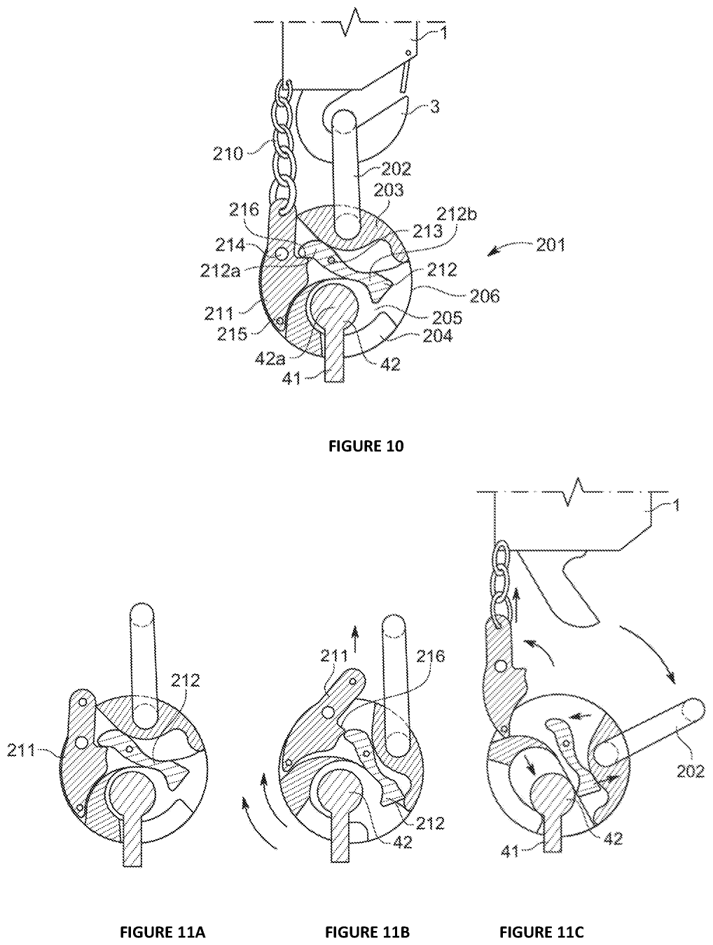

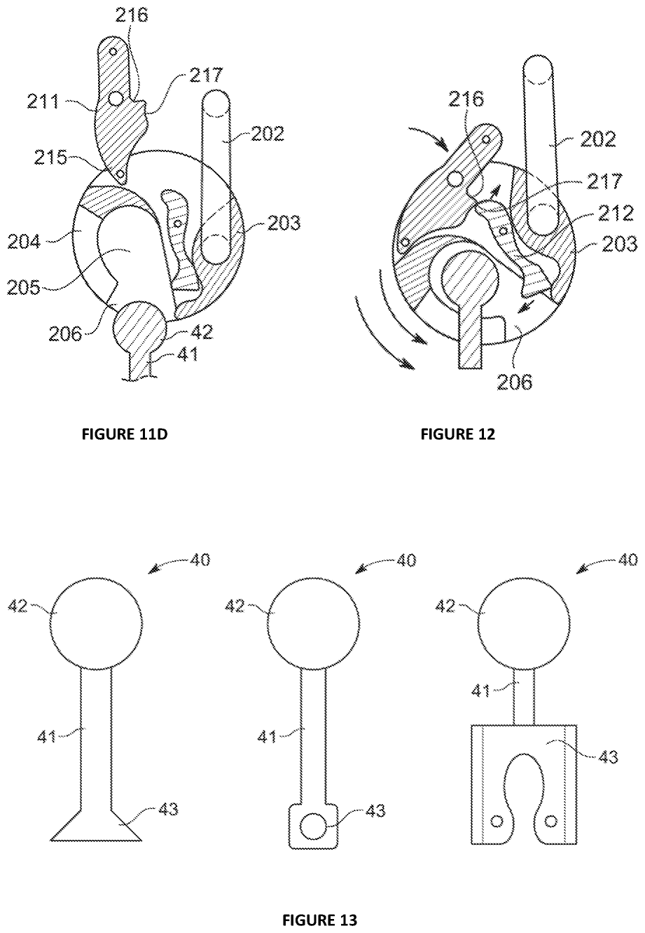

A clutch mechanism (herein a clutch) for use with a remotely operable hook assembly is shown in FIGS. 9A, 9B, 9C and 10. Operation of the clutch is described below with reference to FIGS. 11A to 12. The clutch 201 may be used with the hook assembly 1 described above with reference to FIGS. 1 to 4, or any other hook assembly together with a remotely operable tensioning mechanism, as described in more detail below.

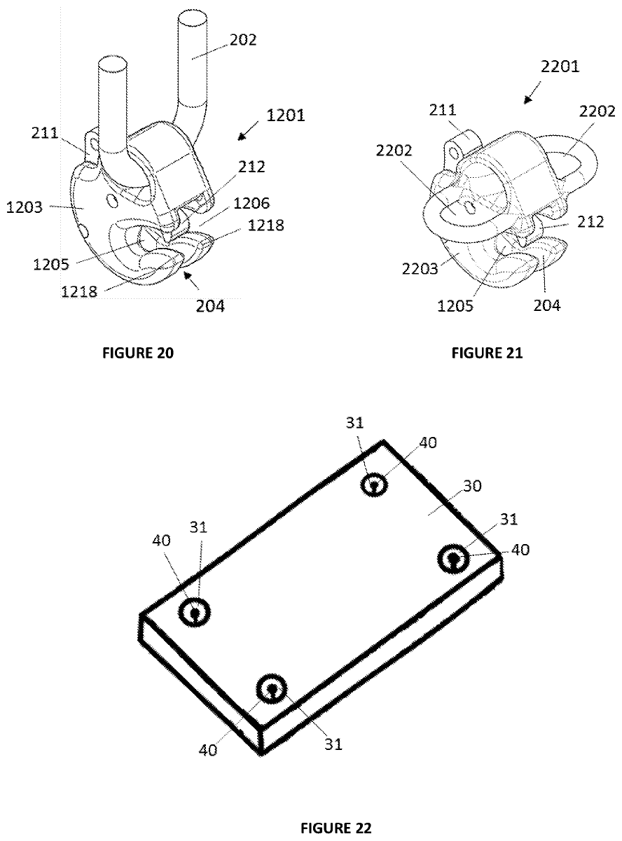

FIG. 10 shows the clutch 201 attached to or coupled with a lifting point. The lifting point 40 comprises a bar or elongate member or neck 41 with an enlarged head 42. The head 42 has a greater lateral dimension than the member or neck 41. Some example lifting points 40 are shown in FIG. 13. In the illustrated embodiments the head is a ball, e.g. spherical. However other shaped heads are possible, such as a lifting point with a ‘ T’ shape. As shown in FIG. 10, the lifting point 40 comprise member 41 and the head 42 at an end of the member. A base 43 for fixing the lifting point 40 to an object to be lifted is provided at an opposite end. The illustrated lifting points are particularly adapted for use with a concrete panel. The base 43 of the lifting point is embedded in a concrete panel during manufacture of the concrete panel, for example by embedding in poured concrete prior to the concrete of the panel setting. In the finished panel the lifting point may be recessed in a recess. As shown in FIG. 21, the recess 31 and lifting point 40 may be provided to a side of the panel 30 for lifting the panel in a horizontal orientation. The clutch may be used to lift a load via any lifting point comprising a member with an enlarged head, as now described.

The clutch 201 has a body 203 and a lifting eye 202 or other coupling for attaching the body to the hook. The body has a cavity 205 with an opening 206 at a side (front side) of the body 203 to receive the head of the lifting point into the cavity, and a slot 204 to receive the member of the lifting point. The slot 204 extends along the cavity between the cavity 205 and an outside of the clutch body 203 so that with the lifting point 40 received in the body, the head 42 is captured in the cavity 205 with the member 41 of the lifting point 40 passing through the slot 204. The slot 204 extends from the cavity 205 and is open to the side and bottom of the clutch body. The slot extends from the cavity opening 206 to a closed end of the cavity 205. The slot 204 is on an opposite side of the cavity 205 to the lifting eye 202, so that when the clutch is lifted by the lifting eye 202 the slot 204 is below the cavity 205. The closed end of the cavity is at least partially below the cavity opening when the clutch is oriented vertically with the lifting eye 202 above the cavity 205.

As best shown in FIG. 9B, the cavity 205 has a width W1 greater than a width W2 of the slot 204 to receive the head 42 of the lifting point 40 above the slot 204. A portion of the body on each side of the slot supports the head of the lifting point so that the load is lifted by the head of the lifting point bearing against the portions of the body on each side of the slot.

As shown in FIG. 10, to lift a load, the clutch 201 is coupled to the lifting point 40 with the head of the lifting point captured in the cavity 205 of the clutch body and with the member 41 extending through the slot 204 of the clutch body. The clutch is attached to the hook 1 via lifting eye 202. The hook is lifted by crane or other lifting apparatus, with the weight of the load taken by the clutch and hook.

When lifting the clutch vertically via the lifting eye 212, the opening 206 is oriented to the side of the body 203 and the elongate member 41 of the lifting point 40 extends from the slot 204 below the lifting eye 202. The clutch body is configured so that when the clutch is lifted vertically by the lifting eye 202, the lifting point 40 is captured in the cavity 205 and extends through the slot 204 vertically below the lifting eye 202.

The clutch has a first lever 211 and a second lever 212. The second lever 212 is movably coupled to the body of the clutch to move between a close position shown in FIGS. 10 and 11A and an open position shown in FIGS. 11C and 11D. The second lever 212 pivots about a pivot point 213 to pivot relative to the body 203 between the close and open positions. In the close position the second lever 212 extends at least partially across the cavity 205 of the body 203 to block the cavity opening 206 so that the lifting point 40 is captured within the cavity 205. In the open position, the second lever 212 is moved out of the cavity 205 to open the cavity to the outside of the body to unblock the cavity opening to allow the lifting point 40 to be passed into the cavity and out of the cavity via the cavity opening 206.

The first lever 211 is movably coupled to the body 203 to move between an engaged position as shown in FIGS. 10 and 11A and a disengaged position as shown in FIGS. 11C and 11D. The first lever 211 pivots about a pivot point 215 to pivot relative to the body 203 between the engaged and disengaged positions. In the engaged position, the first lever 211 engages the second lever 212 to maintain the second lever in the closed position. In the engaged position, the first lever 211 engages the second lever 212 so that the second lever 212 cannot move to the open position. In the disengaged position, the first lever 211 is disengaged from the second lever 212 so that the second lever 212 is free to move to the open position. In the disengaged position the first lever is out of contact with the second lever so that the second lever is free to move relative to the body between the closed and open positions.

The clutch 201 is adapted for remote operation by a pull cord 210 (FIGS. 10 and 11C) attached between the first lever 211 of the clutch 201 and the hook 1 or crane or other lifting equipment attached to the hook 1. A proximal end of the pull cord 210 is attached to the first lever 211 and a distal end is attached to the hook 1 or equipment to which the hook is attached. The pull cord 210 may comprise a chain, a cord, cable or any other (preferably flexible) tensioning member.

The pull cord 210 is attached to a distal end of the first lever 211. The pivot point 215 between the first lever 211 and the body 203 is positioned at or adjacent a proximal end of the first lever 211. The first lever 211 comprises an engagement surface 216 (FIGS. 10 and 11D) to engage the second lever 212. The engagement surface 216 is located on the first lever 211 between the distal end and the proximal end of the first lever, or between the pull cord attachment to the first lever 211 and the pivot point 215 of the first lever on the body 203. The engagement surface 216 of the first lever 211 engages a proximal end of the second lever 212. In the close position a distal end of the second lever 212 extends at least partially across the cavity 205 of the body to block the cavity opening 206. The pivot point 213 for the second lever 212 is located between the distal end and the proximal end of the second lever 212. The second lever has a first lever arm 212a extending between the pivot point 213 and the proximal end and a second lever arm 212b extending between the pivot point 213 and the distal end. The pivot point 213 for the second lever 212 is located between the portion of the second lever 212 that blocks the cavity and the portion of the second lever 212 engaged by the first lever.

Once a lifting operation has been completed an operator lowers the hook 1, clutch 201 and load 30 until the weight of the load is supported by a ground or other surface to remove the weight of the load from the hook 1 and clutch 201. The operator then remotely operates the hook assembly 1 to release the clutch body 203 from the hook assembly 1. For example, the operator actuates the remotely operable hook assembly 1 to release the lifting eye 202 of the clutch 201 from the hook 3 of the hook assembly 1. The lifting eye 202 may fall or drop to one side of the clutch body.

The operator then moves the hook away from the clutch 201, with the clutch 201 remaining coupled to the load via the lifting point 40 captured in the clutch body 203. This tensions the pull cord 210 to pull on the distal end of the first lever 211. As the crane or other lifting equipment continues to move away from the load, the pull cord pulls the first lever 211 outwards from the clutch body 203 and out of engagement with the second lever 212, as shown in FIG. 11B. The pivot point 213 is located towards a side (rear side) of the body opposite to the opening 206, so that the lifting point 40 is located between the opening 206 and the pivot point 213. The pivot point may be located below a central axis 42a of the head 42 of the lifting point, the central axis 42a orthogonal to a longitudinal axis of the member 41 of the lifting point. As the crane/hook pulls on the pull cord and first lever, the clutch body 203 is caused to rotate on the head 42 of the lifting point as shown in FIGS. 11B and 11C and as indicated by the double arrows in FIG. 11B. As tension is applied to the pull cord and first lever, the body 203 is rotated to move the pivot point 213 to be above the lifting point 40 and with the cavity opening 206 below the lifting point. As the body rotates, the elongate member 41 of the lifting point traverses the slot 204 in the clutch body from a closed end of the slot 204 towards the opening 206 of the clutch body cavity. The clutch body 203 rotates about the head 42 of the lifting point until the member 41 of the lifting point 40 extends through the clutch body opening 206. The clutch body may rotate by about 90 degrees or more to move the member 41 of the lifting point 40 from the closed end of the slot 204 to the opening 206. The hook/crane continues to pull on the pull cord until the clutch body 203 hangs from the first lever 211 or the member 41 of the lifting point 40 extends through the clutch body opening 206. With the clutch body hanging from the first lever 211 the cavity 205 is located below the first lever. With the clutch body hanging from the first lever 211 the opening 206 into the cavity 205 of the clutch body 203 may be positioned downwards and with the elongate member 41 of the lifting point 40 extending through the clutch body opening 206. With the lifting point member 41 extending through the opening 206 into the cavity 205 the clutch body 203 may be lifted off the lifting point 40, as shown in FIG. 11D. Once the lifting point has been released from the clutch, the clutch hangs from the hook assembly 1 via the pull cord 210 and the first lever 211. Pulling the pull cord 210 operates the first lever to allow the clutch 201 to be removed from the lifting point. Thus, the first lever may be considered a release member movable relative to the clutch body to release the lifting point from the clutch body.

The clutch 201 with pull cord 210 when used together with a remotely operated hook 1, allows for a load fitted with a lifting point 40 comprising a bar/elongate member 41 with an enlarged head 42 to be remotely released from the lifting equipment. An operator is not required to enter an unsafe area to uncouple the lifting equipment from the load. Typically, the elongate member 41 of the lifting point is in a vertical orientation during a lifting operation.

The clutch 201 may comprise a biased detent to help retain the first lever 211 in the engaged position and therefore the second lever 212 in the closed position. The illustrated embodiment the detent comprises a sprung projection 214 on the first lever or clutch body, such as a sprung ball bearing, that acts against a corresponding surface of the other one of the first lever 211 and clutch body 203. The detent 214 must be depressed to allow the first lever to move out of the engaged position.

To couple the clutch 201 to the lifting point 40, an operator places the clutch 201 over the lifting point 40 with the first lever in the disengaged position and the second lever in the open position, so that the head 42 of the lifting point 40 enters the cavity 205 with the elongate member 41 of the lifting point extending through the cavity opening 206. The second lever 212 is configured so that with the clutch body rotated to position the cavity opening downwards to receive the lifting point the second lever 212 is biased to the open position by gravity. The first arm 212a of the second lever 212 may be accessible to allow the operator to move the second lever. The operator rotates the clutch body onto the lifting point 40 as shown in FIG. 12, until the head of the lifting point is received in the cavity with the member 41 of the lifting point extending through the slot 204 in the body 203 at the closed end of the slot. As mentioned above the clutch body 203 may be rotated approximately 90 degrees or more about the head of the lifting point to couple the clutch body to the lifting point. While simultaneously rotating the clutch body 203 or after rotating the clutch body 203 onto the lifting point, the operator presses the first lever 211 into the clutch body 203 to the engaged position. The second lever is configured so that with the body rotated to position the cavity opening sideways with the lifting eye above the cavity, the second lever 212 is biased to the close position by gravity. For example, the second arm 212b of the second lever 212 is longer and therefore heavier than the first arm 212a of the second lever 212. The first lever 211 may have a cam surface 217 to contact the second lever 212 so that pressing the first lever 211 against the second lever 212 towards the engaged position causes the second lever 212 to move to the close position as indicated in FIG. 12. With the first lever 211 engaged with the second lever 212 with the first lever in the engaged position and the second lever in the closed position, the second lever is locked against movement to the open position and the operator may couple the hook to the clutch body, for example via the clutch lifting eye 202. If not already attached the operator attaches the pull cord 210 between the first lever 211 and the hook 1 or coupled equipment for subsequent release of the clutch. The crane or other lifting equipment can then lift the load via the lifting point 40, clutch 201 and hook assembly 1.

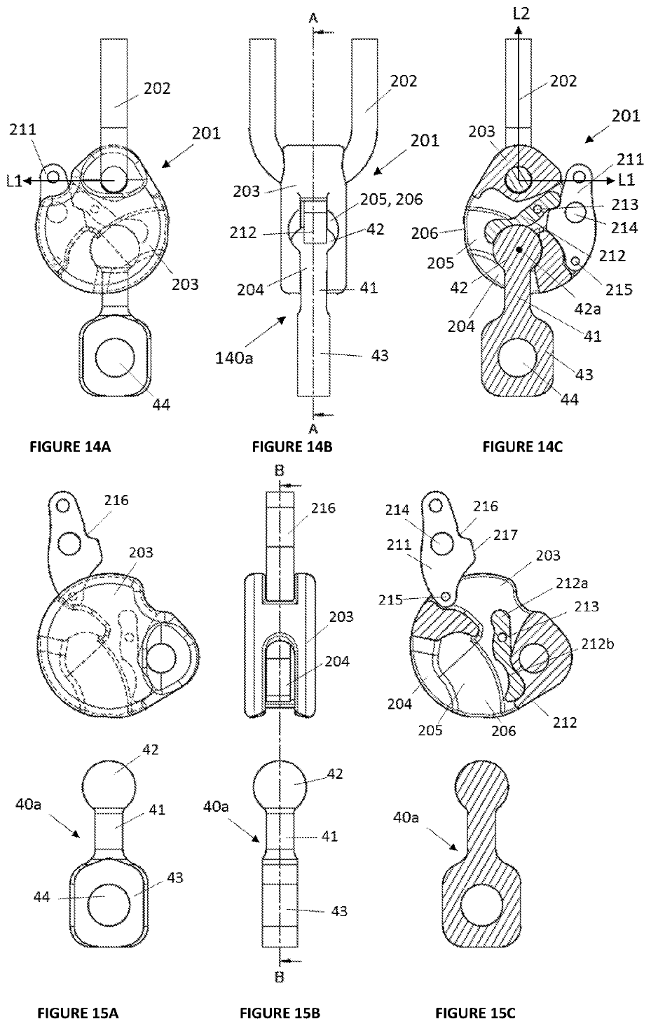

FIGS. 14A to 15C illustrate the clutch 201 as described above with reference to FIGS. 9A to 13, and a lifting point 40a. The lifting point 40a is similar to the lifting point 40 described above, however is configured for use with a lifting strop/chain or the like. The lifting point 40a has a member or neck 41 with a head 42 as described above, and a base 43 opposite the head with an aperture 44 for receiving a lifting strop/chain. In use a strop/chain may be placed through the aperture 44 and around a load to be lifted. This allows the clutch and lifting point to be used to lift beams, trusses or other objects/structures.

Third Clutch Mechanism

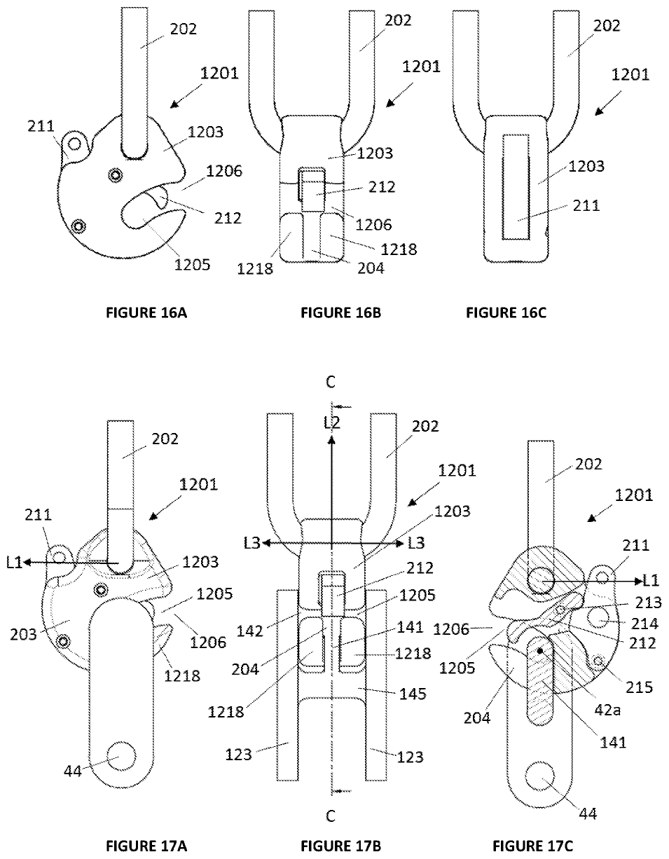

FIGS. 16A to 18C illustrate another clutch 1201 for use with a remotely operable hook assembly. The clutch 1201 has parts or features that are the same as or similar to parts or features of the clutch 201 described above with reference to FIGS. 9A to 13 and as shown in FIGS. 14A to 14C. Same or similar parts or features are identified with the same reference numerals appearing above, or the same reference numerals with a prefix of 1 added. Various features that are the same as or similar to the features of clutch 201 are not described again for brevity.

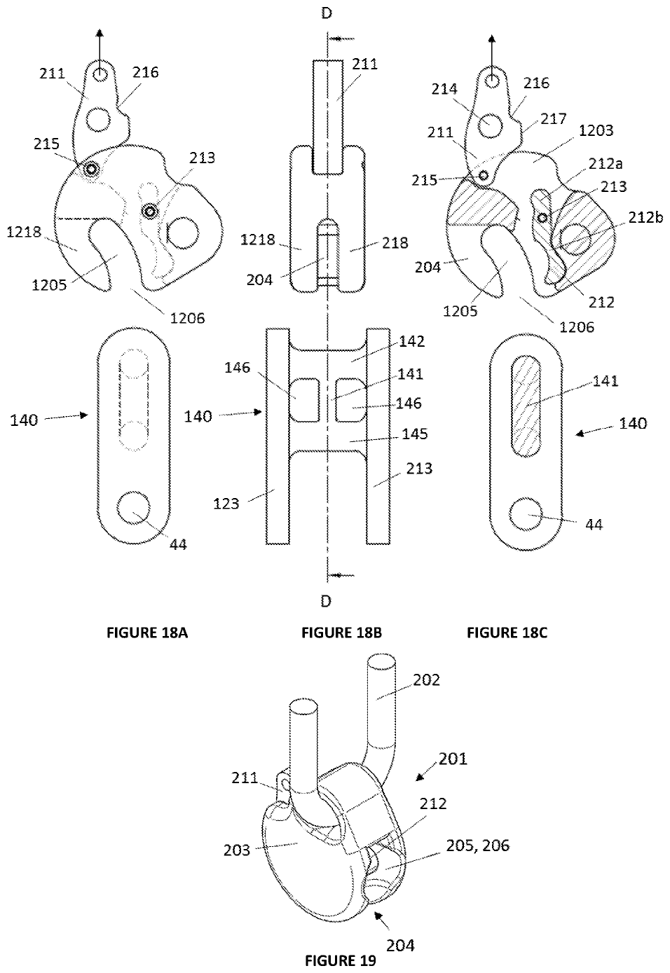

The clutch 1201 is configured for use with an alternative lifting point 140 to the lifting points 40 and 40a described above. The lifting point 140 as best shown in FIGS. 18A to 18C may be described as comprising a ‘T’ shape, with a bar or neck 141 and a cross bar or head 142 attached to a top of the neck 141. The T shaped portion 141, 142 of the lifting point is attached between two side plates or members 123 like side members 23 of the lifting point 20 described above with reference to FIG. 8.

To allow the head 142 of the lifting point 140 to be received in the clutch body, the cavity 1205 extends fully across the clutch body to be open to each side of the clutch body 1203. Once captured in the cavity or head slot 1205, the head 142 of the lifting point extends laterally across the head slot 1205, and the neck member 141 of the lifting point extends through the neck slot 204. Since the neck slot 204 extends partially across the clutch body, the head slot 1205 has a width greater than a width of the neck slot 204.

To couple the clutch 1201 to the lifting point 140, an operator places the clutch 1201 over the lifting point 140 so that the head 142 of the lifting point 140 is received in the cavity or head slot 1205 with the elongate member or neck portion 141 of the lifting point extending through the neck slot 204. To receive the lifting point in the clutch body the operator may rotate the clutch body 1203 to bias and move the second lever to the open position by gravity (FIG. 18D). The operator may rotate the clutch body onto the lifting point 140 (like that shown in FIG. 12), until the head of the lifting point is received in the cavity or head slot 1205 with the member 141 of the lifting point extending through the slot 204 in the body 1203 at the closed end of the slot. The clutch body 203 may be rotated approximately 90 degrees or more about the head of the lifting point to couple the clutch body to the lifting point. The second lever may be configured so that with the lifting point received in the body 1203 with member 141 at the closed end of the slot 204 and with the lifting eye 202 vertically above the lifting point 141, the second lever 212 is biased to the close position by gravity. The operator presses the first lever 211 into the clutch body 1203 to the engaged position. With the first lever 211 engaged with the second lever 212 and the second lever in the closed position, the second lever is locked against movement to the open position and the operator may couple the hook to the clutch body. If not already attached the operator attaches the pull cord 210 between the first lever 211 and the hook 1 or coupled equipment for subsequent release of the clutch. The crane or other lifting equipment can then lift the load via the lifting point 40, clutch 201 and hook assembly 1.

Once a lifting operation has been completed an operator lowers the hook 1, clutch 1201 and load until the weight of the load is supported by a ground or other surface to remove the weight of the load from the hook 1 and clutch 1201. The operator then remotely operates the hook assembly 1 to release the release the lifting eye 202 of the clutch 1201 from the hook assembly 1.

The operator then moves the hook away from the clutch 1201, with the clutch 201 remaining coupled to the load via the lifting point 140 captured in the clutch body 1203. This tensions the pull cord 210 (not shown in FIGS. 16A to 18C) to pull on the distal end of the first lever 211 to pull the first lever 211 outwards from the clutch body 1203 and out of engagement with the second lever 212 (like shown in FIG. 11B). As the crane/hook pulls on the pull cord and first lever, the clutch body 203 is caused to rotate on the head 142 of the lifting point so that the elongate member or neck 141 of the lifting point traverses the slot 204 in the clutch body from the closed end of the slot 204 towards the opening 1206 of the clutch body cavity 1205 to release the lifting point 140 from the clutch body 1203, as described above for the earlier embodiment 201. Once the lifting point has been released from the clutch, the clutch hangs from the hook assembly 1 via the pull cord 210 and the first lever 211.

With particular reference to FIGS. 18A to 18C, the illustrated lifting point 140 comprises two spaced apart members 123, the head 142 or first bar or cross member 142 extending between the side members 123, a second bar or cross member 145 extending between the side members 123, and the elongate member or neck portion 141 extending between the cross members 142, 145. Member 141 extends parallel to the side members 123. The lifting point presents two apertures 146 located between the side members and the first and second cross members and separated by the neck member 141. The clutch body 1203 comprises two spaced apart prongs 1218, the prongs located either side of the slot 204. When the clutch is coupled to the lifting point 140 the prongs are received through the apertures 146 and when lifting a load, the head or first cross member 142 is supported by and bears on the prongs 218.

A bottom end of the side plates 123 may present a base for fixing the lifting point 140 to an object to be lifted, for example the ends of the members 123 may be embedded in a concrete panel during manufacture of the concrete panel. The side members 123 may include an aperture 44 for attaching a strop, as described above for lifting point 40a.

The clutches 201, 1201 when coupled to a lifting point comprising a member with enlarged head (such as a lifting point with a T shaped portion) are configured to take a sideways load. The member 41, 141 of the lifting point 40, 140 received through the slot 204 provides a benefit whereby a sideways load may be applied to the clutch 201, 1201 in a direction away from the cavity or slot opening 206, 1206, as indicated by direction L1 in FIGS. 14A, 14C, 17A and 17C. When a sideways load L1 is applied, the member 41, 141 bears against the clutch body 203, 1203 at a closed end of the slot 204 to prevent the clutch body 203, 1203 rotating relative to the lifting point. Where the lifting point is provided in a recess in a concrete panel, preventing the clutch body from rotating when a side load is applied prevents the clutch or attached lifting equipment bearing against the concrete of the panel, preventing damage to the panel. Where the lifting points 40, 141 are provided to the edge of a panel, the clutches 40, 140 allow for a panel to be lifted from an initial horizontal orientation where an initial lifting force is applied in direction L1, to a vertical orientation where a lifting force is applied in direction L2. This arrangement may be particularly useful for lifting panels/planar members from a horizontal orientation to a vertical orientation, for example when tilting up concrete panels from horizontal to vertical when constructing a building.

One skilled in the art will appreciate that clutch 1201 may be used with a lifting point without a T portion, such as the lifting point 20 shown in FIG. 8, e.g. for providing vertical lifts. However, a lifting point with a T portion is preferred where a sideways load L1 is to be applied. The lifting point 140 may be provided without the second cross member 145 extending between the side members 123, however the second cross member is preferred to support the central member 141 to reduce bending or stress in the central member 141. Where only vertical lifts are required, the clutch may be without the slot 204.

The lifting point 141 may be preferred where a sideways load orthogonal to sideways load L1 is required, e.g. load directions L3 indicated in FIG. 17B. The body 1203 of the clutch may be sized to fit between the side members 123 of the lifting point 141 without a substantial gap between the body 1203 and each side member 123, as shown in FIG. 17B. For example, a small clearance fit may be provided for the body 1203 within the space between members 123. The fit of the body within the lifting point allows the body to bear against the side members when a lifting force is provided orthogonal to the clutch body in either direction L3 as shown in FIG. 17B. A direction L3 orthogonal to the clutch body is a direction parallel to the central axis 42a of the lifting point cross member 142. As the object is lifted from an initial orientation to a lifted orientation, the object and lifting point 141 may be rotated until the clutch body is vertical with load applied in direction L2. Side loading L3 is applied by the clutch body 1203 to the lifting point side members 123. This arrangement may be particularly useful for lifting panels/planar members from a horizontal orientation to a vertical orientation, for example when tilting up concrete panels from horizontal to vertical when constructing a building.

FIG. 21 illustrates another clutch 2201 similar to the clutch 1201 of FIGS. 16A to 18C. The clutch 2201 of FIG. 21 includes an eye 2202 on each side of the clutch body 2203. Each eye is oriented and positioned on the body 2203 to be located above the cavity/slot 1205 and provide a path from below the clutch to above the clutch in use. In the illustrated embodiment each eye is provided by a ‘C’ shaped member with ends connected to the clutch body 2203. In use, a rope or strop or the like may extend from a crane, through the eye 2202 on one side of the clutch body, around a load to be lifted and though an eye of a lifting point received in the clutch body (e.g. eye 44 of lifting point 40a or 140), back around the load and through the eye 2202 on the other side of the clutch body 2203 and back to the hook or crane. The eyes 2202 couple the clutch body 2203 to the rope or strop or the like with the rope or strop passing through the eyes 2202. The eyes 2202 guide the rope or strop to pass around the load and through the eye 44 of the lifting point. During a lifting operation, the load is captured or ‘choked’ between the rope or strop extending around the load and the clutch body 2203. One skilled in the art will appreciate that clutches 201, 1201 described above may also comprises eyes 2202 on each side of the clutch body 203, 1203.

A clutch according to one or more embodiments includes one or more of the following benefits:
The lifting point is positively captured in the closed clutch by a lever at least partially blocking the lifting point releasing from the clutch, so that the lifting point cannot be removed from the clutch, even without the weight of the load taken up by the clutch.
The clutch is remotely operated by a pull cord attached between the clutch and the remotely operable hook or other lifting equipment attached to the hook. This makes the clutch remotely operable together with the hook by simply moving the hook away from the clutch once released from the clutch body. No intervention by a person on the ground is required, with the clutch being operated by the crane operator.
The clutch is easy to use and is easily coupled to the lifting point.
With the clutch coupled to the lifting point the clutch provides for some movement of the clutch on the lifting point, i.e. the clutch is not rigidly fixed to the lifting point. This makes the clutch easier to use.
The clutch may be used with a sideways load applied, so that the clutch can be used in a single lifting operation to lift from a horizontal orientation to a vertical orientation.

Remotely Operable Tensioning Mechanism

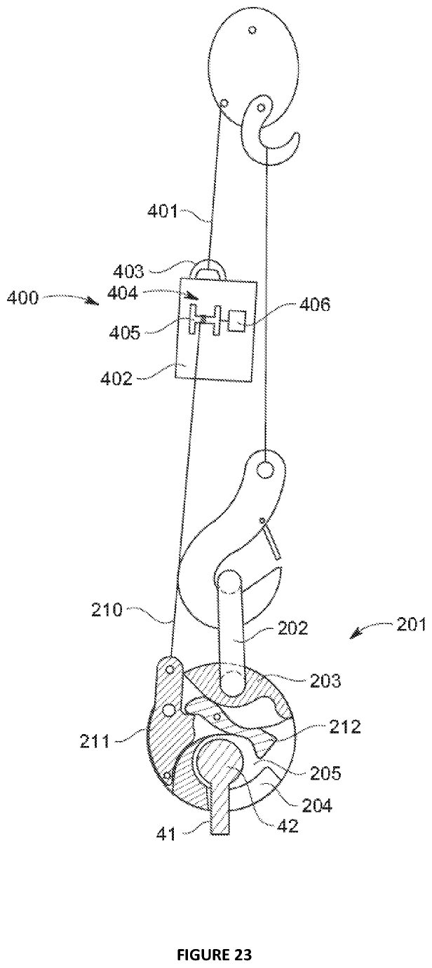

FIG. 23 illustrates a system for use with a lifting apparatus such as a crane and the like for lifting a load via a lifting point. The system comprises a clutch for coupling to the lifting point and a remotely operable tensioning mechanism for remotely operating the clutch. In FIG. 23 the system comprises the clutch mechanism 201 described above. However, alternative clutch mechanisms may be used such as clutches 101, 1201, 2201, where the clutch mechanism comprises a movable release member movable relative to a body of the clutch by applied tension via a pull cord to release the clutch body from a lifting point.

With reference to FIG. 23, the clutch 201 is attached to a lifting apparatus or machine such as a crane via lifting equipment such as a crane hook and/or lifting chain or strop or the like, for lifting a load via a lifting point coupled to the clutch 201. The clutch 201 is remotely operated to release the load lifting point by applying tension to the pull cord 210 as described above. However, in this embodiment, the pull cord 210 is operated by a remotely operable tensioning mechanism 400 attached between the pull cord 210 and the lifting apparatus or lifting equipment. The remotely operable tensioning mechanism 400 may be attached directly to the lifting apparatus (e.g. a crane), or to the lifting apparatus via lifting equipment extending between the lifting apparatus and clutch. For example, the remotely operable tensioning mechanism 400 may be attached to the pull cord 210 and to a crane, crane hook, crane hook block, the lifting chain or strop extending between the crane hook and the clutch 201, or the hook coupled to the clutch. In the illustrated embodiment, the tensioning mechanism 400 is attached to a crane block via a rope 401 by example only. In a preferred arrangement the tensioning mechanism 400 is attached between a crane and the clutch via attachment to the hook coupled to the clutch lifting eye 202.

The remotely operable tensioning mechanism comprises a body or frame 402 with coupling 403 to attach the body or frame 402 to the lifting apparatus. In the illustrated embodiment, the rope 401 is attached between the coupling 403 and the crane block. For example, the coupling 403 may be a lifting eye. An actuator 404 is mounted to the body or frame 402. The clutch pull cord 110, 210 is coupled to the actuator 404. The actuator 404 is remotely operable to apply tension to the clutch pull cord 110, 210 to move the clutch release member 105, 211 and remotely release the clutch body 103, 203 from the lifting point 21, 41. In one embodiment the actuator 404 is remotely operated by a coded digital UHF radio signal, however an alternative known remote communication signal may be used, whether wireless or via hardwired cable connected between the actuator and a remotely located operator control device.

In the illustrated embodiment the remotely operable actuator 404 comprises a spool 405 and a drive mechanism 406 such as motor to drive rotation of the spool 405. The drive is operated upon receipt of a remote signal. The clutch pull cord 110, 210 is coupled to the spool 405 so that rotation of the spool applies tension to the pull cord, to thereby apply tension to the clutch release member 105, 211 and release the clutch 101, 201 from the lifting point 21, 41.

The clutch pull cord 110, 210 may be wound onto the spool 405. A length of the pull cord may be unwound from the spool to be coupled to the clutch release member 105, 211. The drive mechanism 406 is remotely operated to rotate the spool 405, to wind the pull cord 110, 210 onto the spool 405 to apply tension to the clutch release member 105, 211 and release the clutch 101, 201 from the lifting point. The tensioning mechanism may comprise a cord (tensioning member) wound onto the spool 405. In use a length of the tensioning mechanism cord is unwound from the spool 405 and coupled to the clutch pull cord 110, 210 or the clutch release member to couple the clutch pull cord to the spool. A signal is sent to the remotely operable tensioning mechanism to remotely operate the drive 406 to rotate the spool 405 to wind the tensioning mechanism cord onto the spool, to apply tension to the clutch release member via the pull cord 110, 210 and release the clutch 101, 201 from the lifting point 21, 41.

Other remotely operable actuator arrangements may be used. For example, the remotely operable actuator 404 may comprise a linear actuator actuatable between a first position and a second position (for example an extended position and a retracted position). The clutch tensioning member is coupled to the linear actuator. The tensioning member may be coupled to the linear actuator via a gear or other mechanism to provide a mechanical advantage between the linear actuator and the pull cord. A signal is sent to the remotely operable tensioning mechanism to remotely operate the actuator to move from the first position to the second position to apply tension to the clutch pull cord 110, 210 to release the clutch from the lifting point.

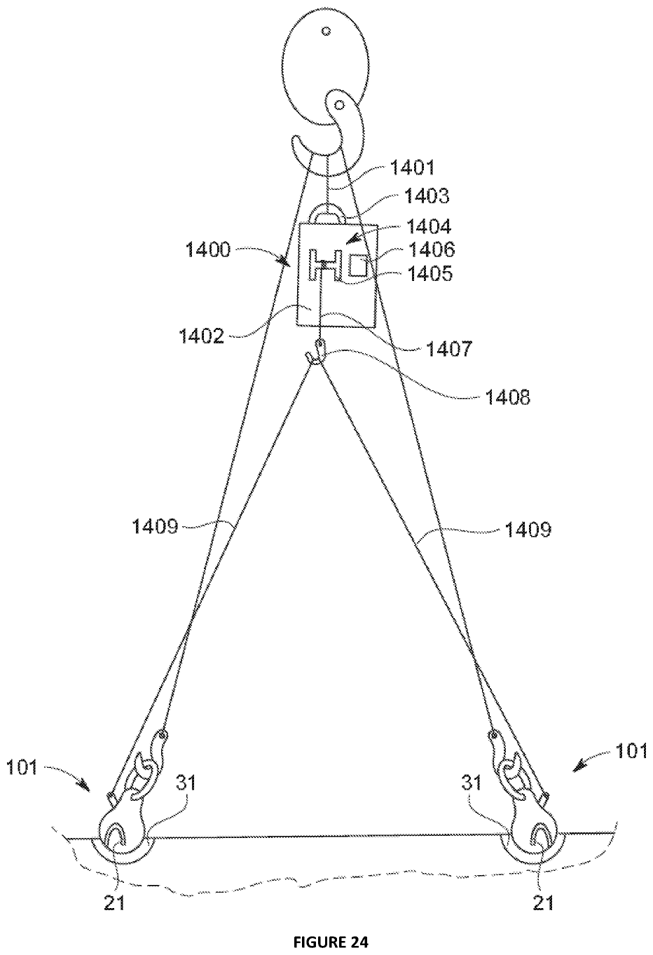

FIG. 24 shows another system for use with a lifting apparatus for lifting a load via a lifting point. The system comprises two clutches 101 for coupling to two lifting points 21 and a remotely operable tensioning mechanism 1400 for remotely operating the two clutches 101. In FIG. 24 the system comprises the clutch mechanism 101 described above. However, the same system may be used with the clutch 201, 1201, 2202 described above or with an alternative clutch mechanism.

In the system of FIG. 24, the remotely operable tensioning mechanism 1400 is the same as the remotely operable tensioning mechanism 400 described above with reference to FIG. 23 but is configured to apply tension to two or more clutches. The same reference numerals appearing above in relation to FIG. 23 are used below or appear in FIG. 24 but with a prefix of “1” added, to reference the same or similar features appearing in both embodiments. The same or similar features are not described again in relation to FIG. 24 for the sake of brevity.

In FIG. 24, the remotely operable tensioning mechanism 1401 comprises a lower coupling 1408 for coupling the pull cord 110 of one or more clutches 101 to the actuator 1404 of the tensioning mechanism 1400. FIG. 24 illustrates two clutches. A further tensioning member 1409 is attached between the lower coupling 1408 and each clutch pull cord 110, or the clutch pull cord is coupled directly to the lower coupling 1408. To release the clutches 110 from the respective lifting points, the actuator 1404 of the remotely operable tensioning mechanism 1400 is operated (e.g. the drive 1406 is operated to rotate spool 1405 to wind tensioning member 1407 onto the spool) to apply tension to the pull cord 110 of both clutches. The tensioning mechanism 1400 applies tension to the two clutches 110 simultaneously.

With reference to FIG. 2B. a transmitter 300 for remotely operating the tensioning mechanism 400, 1400 may have a first button 301 to power the transmitter and a second button 302 to operate the remote tensioning mechanism 400, 1400 to apply tension to the clutch 101, 201. An operator may be required to hold down the power button 301 and the second button 302 to operate the actuator of the remote tensioning mechanism 400, 1400 to release the clutch(s) from the load lift points. The transmitter may have a third button 303 to operate the actuator to release tension from the clutch. Alternatively, the remote tensioning mechanism may be configured so that the actuator automatically releases tension applied to the clutch when the second button is released.

A method for lifting a load comprising a lifting point with a lifting apparatus such as a crane is now described. The method comprises coupling a clutch 101, 201, 1201 to a lifting point 20, 40, 40a, 140 of the load with the clutch attached to the lifting apparatus, for example via lifting equipment such as a lifting chain and hook. The method further comprises attaching a remotely operable tensioning mechanism 400, 1400 between the lifting apparatus and the clutch tensioning member 110, 210. The lifting apparatus is then used to lift the load coupled to the lifting apparatus via the clutch. Once the lift has been completed the load is set down to remove tension from the clutch coupling 102, 202. A signal is then sent to the remotely operable tensioning mechanism 400, 1400 to apply tension to the clutch tensioning member 110, 210 to move the clutch release member 105, 211 and release the clutch body 103, 203 from the lifting point. The lifting apparatus then moves away from the load to move the released clutches away from the lifting point. Where the load comprises two or more lifting points, a clutch 101, 201 is attached to each lifting point, and the remotely operable tensioning mechanism 1400 is attached between the lifting apparatus and the clutch tensioning member 110, 210 of each clutch 101, 201. At the completion of the lift and with tension removed from the clutch couplings 102, 202, a remote signal is sent to the remotely operable tensioning mechanism 1400 to apply tension to the clutch tensioning member of each said clutch to move the clutch release member and release the clutch body of each clutch from each respective lifting point. Further detailed aspects of the method for lifting a load are set out above with reference to the systems of FIGS. 23 and 24.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1.-56. (canceled)

57. A clutch for use with lifting equipment for lifting a load with a lifting point, the clutch comprising:
a body;
a coupling to couple the body to the lifting equipment;
wherein the body has a cavity with an opening at a side of the body to receive the lifting point into the cavity;
a first lever and a second lever;
wherein the second lever is movably coupled to the body of the clutch to move between a close position and an open position, in the close position the second lever extends at least partially across the cavity of the body to block the cavity opening to capture the lifting point within the cavity, and in the open position the second lever is moved out of the cavity to unblock the opening to allow the lifting point to be passed into the cavity and out of the cavity via the cavity opening;
wherein the first lever is movably coupled to the body to move between an engaged position and a disengaged position, in the engaged position the first lever engages the second lever to maintain the second lever in the closed position, and in the disengaged position the second lever is disengaged from the second lever so that the second lever is free to move to the open position; and
a tensioning member, a proximal end of the tensioning member attached to the first lever and a distal end of the tension member adapted for attachment to the lifting equipment;
wherein with the lifting point captured in the cavity, and without application of a lifting force to the coupling, pulling the tensioning member:
moves the first lever from the engaged position to the disengaged position to allow the second lever to move from the closed position to the open position, and
rotates the clutch body relative to the lifting point to release the lifting point from the clutch body.

58. The clutch as claimed in claim 57, wherein the first lever pivots about a pivot point to pivot relative to the body between the engaged and disengaged positions.

59. The clutch as claimed in claim 58, wherein the tensioning member is attached to a distal end of the first lever.

60. The clutch as claimed in claim 58, wherein the pivot point between the first lever and the body is positioned at or adjacent a proximal end of the first lever.

61. The clutch as claimed in claim 58, wherein the pivot point is located towards a side of the body opposite to the cavity opening, so that the lifting point is received in the cavity between the pivot point and the opening.

62. The clutch as claimed in claim 58, wherein the pivot point is located below a central axis of the head of the lifting point.

63. The clutch as claimed in claim 57, wherein the first lever comprises an engagement surface to engage a proximal end of the second lever.

64. The clutch as claimed in claim 63, wherein the engagement surface is located on the first lever between a distal end and a proximal end of the first lever, or between the tensioning member attachment to the first lever and a pivot point of the first lever on the body.

65. The clutch as claimed in claim 57, wherein the first lever comprises a cam surface to contact the second lever so that pressing the first lever against the second lever towards the engaged position causes the second lever to move to the close position.

66. The clutch as claimed in claim 57, wherein in the close position a distal end of the second lever extends at least partially across the cavity of the body to at least partially block the cavity opening.

67. The clutch as claimed in claim 57, wherein the second lever pivots about a pivot point to pivot relative to the body between the close and open positions.

68. The clutch as claimed in claim 67, wherein the pivot point for the second lever is located between a distal end and a proximal end of the second lever, so that the first lever has a first lever arm extending between the pivot point and the proximal end and a second lever arm extending between the pivot point and the distal end.

69. The clutch as claimed in claim 57, wherein the second lever is configured so that with the clutch body rotated to position the cavity opening downwards, the second lever is biased to the open position by gravity.

70. The clutch as claimed in claim 57, wherein the second lever is configured so that with the body rotated to position the lifting eye above the cavity, the second lever is biased to the close position by gravity.

71. The clutch as claimed in claim 57, wherein the clutch comprises a sprung detent to retain the first lever in the engaged position and therefore the second lever in the closed position.

72. The clutch as claimed in claim 57, wherein when the clutch is released from the lifting point the clutch hangs from the tensioning member and first lever.

73. The clutch as claimed in claim 57, the clutch comprising:
the cavity configured to receive a head of a member of the lifting point, and a slot extending along the cavity with a closed end and an open end, wherein the open end of the slot is at the cavity opening so that the body is configured to capture the head in the cavity with the member of the lifting point passing through the slot,
wherein with the head captured in the cavity and the member of the lifting point at the closed end of the slot, pulling the tensioning member rotates the body relative to the lifting point to traverse the member of the lifting point along the slot to the cavity opening to allow the clutch to be lifted away from the lifting point and release the lifting point from the clutch body.

74. The clutch as claimed in claim 73, wherein the clutch is configured to have a sideways load applied in a direction away from the cavity opening with the member of the lifting point bearing against a closed end of the slot to prevent the clutch body rotating relative to the lifting point.

75. The clutch as claimed in claim 73, wherein the cavity is a head slot extending fully across the body for receiving the head of the lifting point and the slot of claim 17 is a neck slot for receiving the member of the lifting point extending from the head such that the body comprises two spaced apart prongs to support the head of the lifting point during a lifting operation.

76. The clutch as claimed in claim 73 and a said lifting point, wherein the head of the lifting point is a ball, or wherein the head is a cross bar such that the lifting point comprises a T-shaped portion.

77. The clutch as claimed in claim 75 and a said lifting point, wherein the lifting point comprises:
two spaced apart side members,
the head is a first cross member extending between the two side members,
a second cross member extending between the side members, and
an elongate member or neck portion extending between the cross members,
such that the lifting point presents two apertures to receive the prongs of the clutch body with the head received in the head slot and the neck portion received in the neck slot.

78. The clutch and lifting point as claimed in claim 77, wherein the body of the clutch is sized to fit between the side members of the lifting point without a substantial gap between the body and each side member, so that the clutch is configured to have a sideways load applied orthogonal to the body of the clutch by the body bearing against the side members.

79. The clutch and lifting point as claimed in claim 76, wherein the lifting point comprises an aperture opposite to the head for attaching a strop or lifting chain or the like.

80. A lifting point comprising:
two spaced apart side members;
a first cross member extending between the two side members;
a second cross member extending between the side members; and
an elongate member or neck portion extending between the cross members;
such that the lifting point presents two apertures located between the side members and the first and second cross members and separated by the elongate member or neck portion to receive prongs of a clutch body of a clutch for lifting a load with the first cross member supported by the prongs.
